(19) United States
(12) Patent Application Publication
(10) Pub. No.: US 2017/0369724 A1
(43) Pub. Date: Dec. 28, 2017

(54) IMAGE RECORDING METHOD AND INK JET INK COMPOSITION

(71) Applicant: Seiko Epson Corporation, Tokyo (JP)

(72) Inventors: Toru SAITO, Yamagata (JP); Keitaro NAKANO, Matsumoto (JP); Toshiyuki YODA, Matsumoto (JP); Hitoshi TSUCHIYA, Chino (JP); Tsuyoshi SANO, Shiojiri (JP)

(21) Appl. No.: 15/628,897

(22) Filed: Jun. 21, 2017

(30) Foreign Application Priority Data
Jun. 22, 2016 (JP) 2016-123669

(51) Int. Cl. C09D 11/322; C09D 11/107; C09D 11/101; C09D 11/38; B41J 2/155

(52) U.S. Cl. CPC C09D 11/322; C09D 11/38; B41J 2/155; C09D 11/101; C09D 11/107

(57) ABSTRACT

An image recording method according to this invention is an image recording method using an ink jet ink composition containing a pigment, in which the maximum particle size of the pigment is 2.5 μm or less and recording is performed with continuous scanning time of 10 minutes or more.

### BACKGROUND

### 1. Technical Field

The present invention relates to an image recording method and an ink jet ink composition.

### 2. Related Art

In recent years, a recording method of an ink jet system uses an ink jet composition (hereinafter also referred to as “ink”) containing a pigment as a coloring material in order to form an image having high water resistance, solvent resistance, abrasion resistance, and the like on the surface of a recording medium and, particularly, a radiation curing type ink jet ink composition which is cured when radiation is emitted as an ink in order to record an image having higher water resistance and the like. In general, the radiation curing type ink jet ink composition contains a polymerizable compound, such as a monofunctional monomer and a polyfunctional monomer, a photopolymerization initiator, a pigment, and the like.

In an image recording method using such a pigment ink, an ink jet recording apparatus having a line head as a recording head has been used in some cases. By the use of the line head as the head, high-speed continuous printing can be achieved in the image recording using the ink jet recording apparatus.

Herein, in order to perform the high-speed continuous printing over a long period of time by the ink jet recording apparatus having a line head, the discharge stability for stably discharging an ink is particularly important. Then, for example, JP-A-2015-51579 discloses an ink jet recording method using a line head in which the opening area of an ink discharge port is 100 μm² or more and 350 μm² or less, the total number of nozzles in a nozzle array is 1200 or more, and the nozzle array length is 2 inches or more and which can be driven at a driving frequency of 1 kHz or more and 10 kHz or less as a recording head for an ink jet recording of a thermal system and uses an ink containing a coloring material, an acetylene glycol-based surfactant, and water as an ink.

However, also in the recording method, when the continuous printing is performed over a long period of time (for example, 10 minutes or more), poor discharge sometimes occurs. It has been clarified that, particularly in high-speed continuous printing using an ink containing a specific pigment (for example, specific yellow pigment), particularly poor discharge is likely to occur due to clogging of a nozzle resulting from the accumulation of coarse particles, the occurrence of cavitation in a head, and the like.

### SUMMARY

An advantage of some aspects of the invention is to provide an image recording method using an ink jet ink composition containing a pigment in which poor discharge is reduced to achieve excellent discharge stability and an ink jet ink composition for use in the image recording method.

The present invention has been made in order to solve at least partially the above-described problems and can be realized as the following aspects or application examples.

### Application Example 1

One aspect of an image recording method according to the present invention is an image recording method using an ink jet ink composition containing a pigment, in which the maximum particle size of the pigment is 2.5 μm or less and recording is performed with continuous scanning time of 10 minutes or more.

According to the image recording method of Application Example 1, due to the fact that the maximum particle size of the pigment is 2.5 μm or less, an image recording method in which poor discharge is reduced to achieve excellent discharge stability is obtained even in recording with continuous scanning time of 10 minutes or more.

### Application Example 2

In the application example above, recording can be performed with one pass printing using a line printer having a line head having a width equal to or larger than the recording width of a recording medium.

According to Application Example 2, in the recording with one pass printing using the line printer having a line head, image recording excellent in discharge stability can be performed over a long period of time.

### Application Example 3

In the application example above, the dissolved oxygen concentration of the ink jet ink composition can be 10 kPa or less.

According to Application Example 3, by setting the dissolved oxygen concentration to 10 kPa or less, the occurrence of cavitation in the head is prevented, so that an image recording method having more excellent discharge stability can be provided.

### Application Example 4

In the application example above, the pigment can have an aspect ratio of 2.5 or more and an average particle size of 170 nm or more.

According to Application Example 4, also when a pigment has an aspect ratio of 2.5 or more and an average particle size of 170 nm or more is used, an image recording method in which poor discharge is reduced to achieve more excellent discharge stability can be provided.

### Application Example 5

In the application example above, the ink jet ink composition can be a radiation curing type ink jet ink composition.

According to Application Example 5, also when the ink jet ink composition is the radiation curing type ink jet ink composition, an image recording method having excellent discharge stability can be provided.

### Application Example 6

In the application example above, at least one kind selected from the group consisting of a compound represented by the following general formula (I) and monofunctional (meth)acrylate having an aromatic ring skeleton other than the compound represented by the following general formula (I) can be contained,

CH₂═CR¹—COOR²—O—CH═CH—R³ (I),

in which, in Formula (I), R¹ is a hydrogen atom or a methyl group, R² is a divalent organic residue having 2 to 20 carbon atoms, and R³ is a hydrogen atom or a monovalent organic residue having 1 to 11 carbon atoms.

According to Application Example 6, an image excellent in ink curability is obtained.

### Application Example 7

In the application example above, at least one kind selected from the group consisting of C.I. Pigment Yellow 155, C.I. Pigment Yellow 128, and C.I. Pigment Red 122 can be contained as the pigment.

According to Application Example 7, even in the case of pigments which are hard to be dispersed and are likely to form coarse particles, such as C.I. Pigment Yellow 155, C.I. Pigment Yellow 128, and C.I. Pigment Red 122, as the pigment, an image recording method in which poor discharge is reduced to achieve more excellent discharge stability can be provided.

### Application Example 8

In the application example above, the recording method includes discharging liquid droplets drop by drop from a nozzle using a piezoelectric ink jet head having an ink pressure chamber, in which recording can be used at least a droplet satisfying the following formula (1),

0.13≦{(Discharge amount per droplet)/(Capacity of ink pressure chamber)}×100 (1).

According to Application Example 8, a head satisfying Formula (1) is likely to cause cavitation, and therefore the discharge is affected by the ink composition, so that the nozzle is easily clogged and poor discharge is likely to occur, but, by the use of the ink of the application example, an image recording method excellent in discharge stability can be provided.

### Application Example 9

One aspect of an ink jet ink composition according to the present invention is used for the image recording method described in any one of Application Example 1 to Application Example 8.

According to Application Example 9, due to the fact that the maximum particle size of the pigment is 2.5 μm or less, an ink jet ink composition for continuous-scanning one pass printing is obtained in which poor discharge is reduced to achieve excellent discharge stability even in recording with continuous scanning time of 10 minutes or more.

### BRIEF DESCRIPTION OF THE DRAWINGS

The invention will be described with reference to the accompanying drawings, wherein like numbers reference like elements.

FIG. 1 is a block diagram illustrating an example of the entire configuration of an ink jet recording apparatus for use in this embodiment.

FIG. 2 is an exploded perspective view schematically illustrating a head of the ink jet recording apparatus.

FIG. 3 is a schematic view of the cross section of a principal portion of the head of the ink jet recording apparatus.

FIG. 4 is a schematic cross sectional view illustrating an example of the peripheral of a head unit, a transporting unit, and an irradiation unit in a line printer which is an example of the ink jet recording apparatus.

### DESCRIPTION OF EXEMPLARY EMBODIMENTS

Hereinafter, some embodiments of the present invention are described. The embodiments described below describe an example of the invention. The present invention is not limited to the following embodiments at all and also includes various kinds of modifications implemented insofar as the scope of the present invention is not altered. All the configurations described below are not necessarily indispensable configurations of the present invention.

### 1. IMAGE RECORDING METHOD

An image recording method according to one embodiment of the present invention is an image recording method using an ink jet ink composition containing a pigment, in which the maximum particle size of the pigment is 2.5 μm or less and recording is performed with continuous scanning time of 10 minutes or more.

Hereinafter, with respect to the image recording method according to this embodiment, the configuration of an apparatus and an ink jet ink composition capable implementing the method are described in this order, and then processes of the method is described in detail.

Herein, in this specification, the image recording method means recording an image on a recording medium by discharging an ink from a nozzle of a head of an ink jet recording apparatus. The “(recorded) image” refers to a printed pattern formed from a dot group and also includes text printing and solid printing.

In this specification, the continuous scanning means that a recording medium continuously moves in one direction relatively to the nozzle to continuously perform scanning without interrupting the scanning. The continuous scanning includes not only continuous discharging in which an ink is continuously discharged from the same nozzle but a case where an ink is intermittently discharged. More specifically, the continuous scanning means continuously performing image recording to a transported recording medium using a line printer as the ink jet recording apparatus. Therefore, intermittently discharging an ink means that all or some of the nozzles have non-discharge time. Herein, the non-discharge time is 10 seconds or less, preferably 1 second or less, and more preferably 0.1 second or less.

The continuous scanning time is preferably 20 minutes or more and more preferably 30 minutes or more. When image recording is continuously performed, continuous scanning of 10 minutes or more is not achieved in actual due to a maintenance operation of a nozzle and the like. However, according to one embodiment of the invention of this application, continuous scanning of 10 minutes or more can be performed without suspending the scanning for performing the maintenance operation of a nozzle and the like.

In this specification, the “discharge stability” refers to a property with which ink liquid droplets are stably discharged from a nozzle.

### 1.1. Apparatus Configuration

An ink jet recording apparatus for use in the image recording method according to this embodiment has a piezoelectric ink jet head (hereinafter also simply referred to as “head”) employing a piezoelectric system of simultaneously applying pressure and a record information signal to an ink by a piezoelectric element to discharge/record ink liquid droplets as a system of discharging an ink from a nozzle. Such an ink jet recording apparatus has a piezoelectric ink jet head having a nozzle discharging an ink composition, a pressure chamber applying pressure to the ink composition to discharge the ink composition from a nozzle, and a connection portion connecting the pressure chamber and the nozzle, for example.

Hereinafter, the piezoelectric ink jet head for use in this embodiment is described taking an on-carriage type printer in which an ink cartridge is mounted on a carriage as an example but the apparatus having the piezoelectric ink jet head for use in the present invention is not limited to the on-carriage type printer and may be an off-carriage type printer in which an ink cartridge is not mounted on a carriage and fixed to the outside.

The printer for use in the following description is a line printer in which a head is formed so as to have a width equal to or larger than the width of a recording medium and which discharges liquid droplets on a recording medium without moving the head to perform recording with one pass printing. However, the ink jet recording apparatus for use in the present invention is not limited to the line printer and may be a serial printer in which a head is mounted on a carriage moving in the predetermined direction and which discharges liquid droplets on a recording medium by the movement of the head moves with the movement of the carriage.

In each drawing for use in the following description, the scale of each member is altered as appropriate so that each member can be recognized.

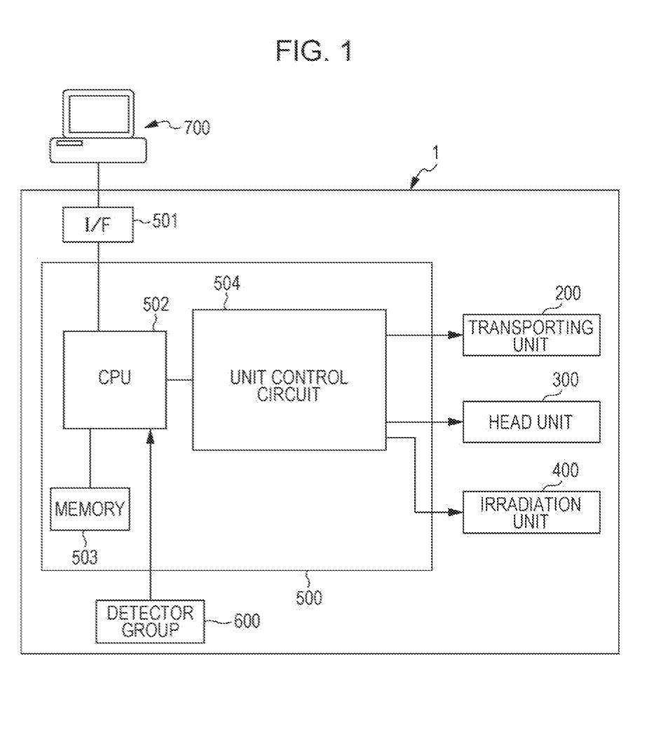

FIG. 1 is a block diagram illustrating an example of the configuration of a printer 1 which is an example of the apparatus having the piezoelectric ink jet head implementing the image recording method according to this embodiment. The printer 1 is electrically connected to a computer 700. A printer driver is installed in the computer 700. The computer 700 outputs, in order to cause the printer 1 to record an image, print data according to the image to the printer 1. The printer 1 has a transporting unit 200, a head unit 300, an irradiation unit 400, a controller 500, a detector group 600, and an interface (I/F) 501. The printer 1 receiving print data from the computer 700 which is an external apparatus records an image on a recording medium according to the print data under the control of each unit by the controller 500.

The transporting unit 200 transports a recording medium in the predetermined direction (hereinafter referred to as transporting direction).

The head unit 300 ejects an ink described later to a recording medium.

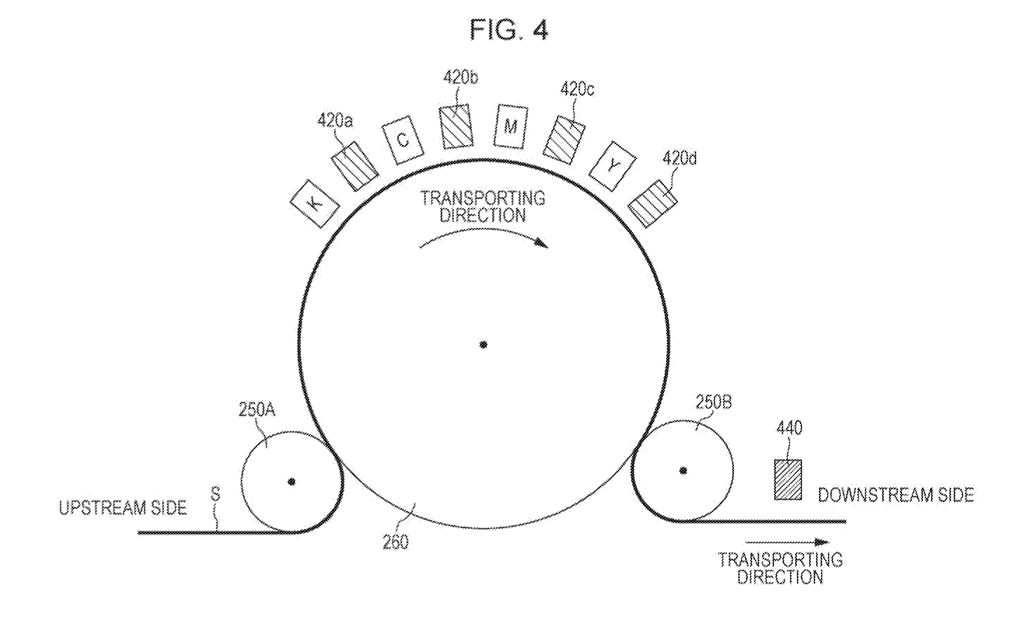

The irradiation unit 400 emits radiation to an ink landing on a recording medium when recording is performed using a radiation curing type ink jet ink composition described later as the ink. Dots formed on the recording medium are cured by receiving the emission of the radiation from the irradiation unit 400. In this embodiment, the irradiation unit 400 has a configuration of having irradiation portions for temporary curing 420a, 420b, 420c, and 420d and an irradiation portion for complete curing 440 (FIG. 4) and performing two stages of curing (radiation irradiation) of the temporary curing and the complete curing to the dots formed on the recording medium. Each irradiation portion has a light emitting diode (LED) or an LD (Laser Diode) or a lamp (a metal halide lamp, a mercury lamp, and the like) as a light source for the irradiation. Each irradiation portion can easily vary the irradiation energy by controlling the size of an input current.

The controller 500 is a control unit (control portion) for controlling the printer 1. The controller 500 has a CPU 502, a memory 503, and a unit control circuit 504, and which transmits and receives data through an interface 501 between the computer 700 which is an external apparatus and the printer 1. The CPU 502 is an arithmetic processing device for controlling the entire printer. The unit control circuit 504 has a circuit for controlling each unit. The memory 503 secures an area for storing programs, a working area, and the like of the CPU 502 and has storage elements, such as a RAM and an EEPROM. The CPU 502 controls each unit through the unit control circuit 504 according to the programs stored in the memory 503.

The state in the printer 1 is monitored by the detector group 600, and the detector group 600 outputs the detection result to the CPU 502. The detector group 600 contains a rotary encoder (not illustrated), a recording medium detection sensor (not illustrated), and the like, for example. The rotary encoder can detect the amount of rotations of a transporting drum 260 (FIG. 4) of the transporting unit 200 and can detect the transportation amount of a recording medium based on the detection result of the rotary encoder. The recording medium detection sensor detects the position of the tip of the recording medium. The controller 500 controls each unit based on the detection results output from the detector group 600.

In this embodiment, the printer 1 can record inks of various colors (form an image) on a recording medium. As an image recording method, forming an image using inks of four colors of CMYK (Cyan, Magenta, Yellow, Black) or forming a background image giving excellent concealment properties to a recording medium using a white ink is mentioned, for example.

As described above, in this embodiment, the printer 1 is the ink jet recording apparatus of the line system and has the line head having a width equal to or larger than the recording width of a recording medium as a head. In image recording, an ink is discharged from the line head to a recording medium while the line head and the recording medium move the positions relatively to the scanning direction crossing the width direction, i.e., the recording medium which is scanned relatively to the line head. Then, in the line printer, the head is not (hardly) moved and fixed and recording is performed by one pass (single pass). The line printer is more advantageous than the serial printer in the fact that the recording speed is high.

Herein, the “line head having a width equal to or larger than the recording width of a recording medium” means a line head in which the line head length (width) is equal to or larger than the length equivalent to the width (recording width) of a recording medium to which an ink is to be discharged (an image is to be recorded).

On the other hand, in a serial printer which is an ink jet recording apparatus of a serial system performs main scanning (pass) in which an ink is discharged while a head is moving in the main scanning direction crossing the subscanning direction of a recording medium and performs recording by two or more passes (multipass).

### 1.1.1. Piezoelectric Ink Jet Head

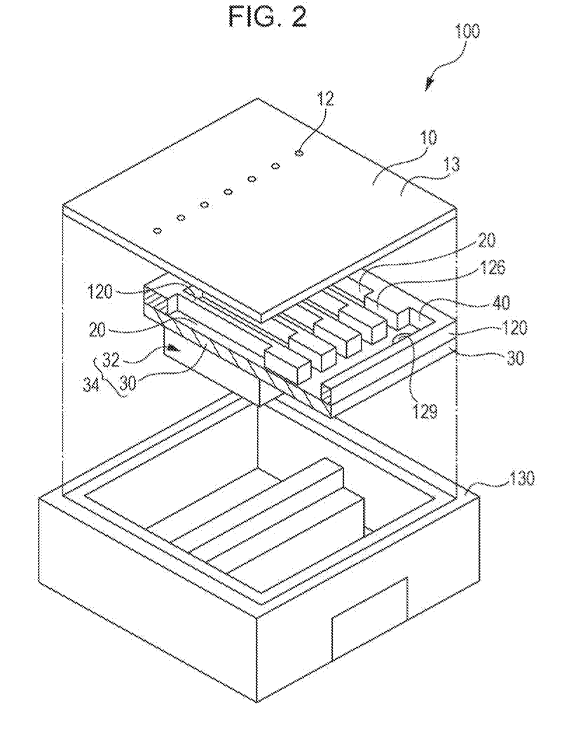

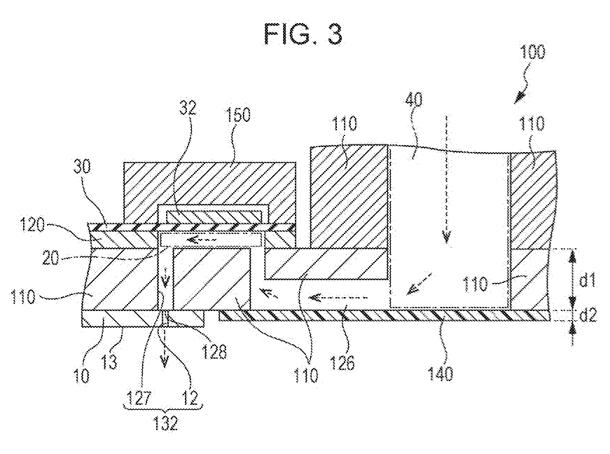

FIG. 2 is an exploded perspective view schematically illustrating a piezoelectric ink jet head 100 configuring the line head of the printer 1. FIG. 3 is a schematic view of the cross section of a principal portion of the piezoelectric ink jet head 100 and schematically illustrates the flow of an ink from an ink supply chamber 40 to nozzles 12 in an ink discharge operation by the dashed line arrows.

In FIG. 2 and FIG. 3, a piezoelectric element 32 is illustrated in a simplified manner. In this embodiment, the piezoelectric ink jet head 100 is configured so as to have a communication plate 110 and a cover 150 but the communication plate 110 and the cover 150 are omitted in FIG. 2.

The head unit 300 (FIG. 1) of the printer 1 has the piezoelectric ink jet head 100 which discharges an ink to a recording medium described later to perform recording. The printer 1 may be configured so as to have one head per ink of one color or to have a plurality of heads per ink of one color. When the plurality of piezoelectric ink jet heads are provided per ink of one color, the line head may be configured by arranging the plurality of heads in the width direction of the recording medium. In this case, the above-described recording width can be lengthened. When recording is performed using inks of a plurality of colors, the printer 1 has the piezoelectric ink jet head for each ink. The piezoelectric ink jet head can be configured as follows, for example.

As illustrated in FIG. 2, the piezoelectric ink jet head 100 has a nozzle plate 10 having a plurality of nozzle openings 12 in the surface facing a recording medium, a plurality of pressure chambers 20 communicating with each of the plurality of nozzle openings 12 formed in the nozzle plate 10, a diaphragm 30 varying the capacity of each of the plurality of pressure chambers 20, the ink supply chamber 40 supplying an ink to the plurality of pressure chambers 20, and a case 130.

The nozzle plate 10 has the plurality of nozzle openings 12 for discharging an ink. The plurality of nozzle openings 12 are arranged in the shape of an array and a nozzle surface 13 is formed on the surface of the nozzle plate 10. The number of the nozzle openings 12 provided in the nozzle plate 10 is not particularly limited. In the head 100 for use in this embodiment, the nozzle density in the array direction of the nozzle openings 12 is preferably 200 dpi or more. More specifically, the interval between the nozzle openings 12 adjacent to each other of the arranged nozzle openings 12 is preferably 127 μm or less. By setting the nozzle density to 200 dpi or more, the total ink ejection amount can be maintained even when liquid droplets are miniaturized. The nozzle density is more preferably 240 dpi or more, still more preferably 250 dpi or more, yet still more preferably 300 dpi or more, further yet still more preferably 400 dpi or more, and most preferably 500 dpi or more. The upper limit of the nozzle density is preferably 2000 dpi or less and more preferably 1000 dpi or less.

As the material of the nozzle plate 10, silicon, stainless steel (SUS), and the like can be mentioned, for example. The case where the material of the nozzle plate 10 is an alloy containing iron (Fe) as the main component (50% or more) and 10.5% or more of chromium (Cr) is more preferable because both rigidity and difficulty of rusting can be achieved. The thickness of the nozzle plate 10 is not particularly limited and is preferably 50 μm or less, more preferably 20 μm or less, and still more preferably 1 μm or more and 10 μm or less, for example.

The piezoelectric ink jet head 100 has a pressure chamber substrate 120 for forming pressure chambers 20. As the material of the pressure chamber substrate 120, silicon and the like are mentioned, for example. As illustrated in FIG. 3, the pressure chamber substrate 120 has a communication plate 110 as a flow passage formation substrate between the pressure chamber substrate 120 and the nozzle plate 10. Due to the fact that the communication plate 110 partitions the space between the nozzle plate 10 and the pressure chamber substrate 120, the ink supply chamber 40 (liquid storage portion), a supply port 126 communicating with the ink supply chamber 40, and the pressure chamber 20 communicating with the supply port 126 are formed. More specifically, the ink supply chamber 40, the supply port 126, and the pressure chamber 20 are partitioned by the nozzle plate 10, the communication plate 110, the pressure chamber substrate 120, and the diaphragm 30.

The communication plate 110 has a communication opening 127 communicating with the nozzle opening 12 from the pressure chamber 20. In an end portion of the communication opening 127 formed in the surface where the communication plate 110 contacts the nozzle plate 10, an ink discharge port 128 is formed. The discharge port 128 communicates with the nozzle opening 12 formed in the nozzle plate 10.

The diaphragm 30 is provided in contact with the pressure chamber substrate 120. The piezoelectric element is formed in contact with the diaphragm 30. The piezoelectric element 32 is electrically connected to a piezoelectric element driving circuit (not illustrated) in the controller 500 and can operate (vibrate, deform) based on a signal of the piezoelectric element driving circuit. The diaphragm 30 is deformed by the operation of the piezoelectric element 32 to be able to vary the capacity of the pressure chamber 20, whereby the internal pressure of the pressure chamber 20 can be varied. The piezoelectric element 32 is not particularly limited. For example, an element (electromechanical conversion element) of a type which causes deformation by applying a voltage can be mentioned. Thus, a piezoelectric actuator 34 is configured by the piezoelectric element 32 and the diaphragm 30 in this embodiment.

In this example, the pressure chamber 20 is partitioned by the communication plate 110, the pressure chamber substrate 120, and the diaphragm 30. However, the pressure chamber 20 can be formed by an appropriate member insofar as the capacity is variable by the vibration of the diaphragm 30. The number, the shape, the material, and the like of members therefore are arbitrary. The diaphragm 30 may be integrated with electrodes (for example, formed of Pt or the like) configuring the piezoelectric element 32.

In this embodiment, the piezoelectric ink jet head 100 is preferably configured so that the interval between the nozzle openings 12 is 127 μm or less and a piezoelectric material is disposed between two electrodes as the piezoelectric element 32. More specifically, the piezoelectric actuator 34 preferably has an aspect of a thin film shape as a whole in which one electrode, a layer of a piezoelectric material (for example, PZT (lead zirconate titanate)), and the other electrode are successively laminated on the diaphragm 30, for example.

The material of the diaphragm 30 is not also particularly limited. For example, silicon dioxide (SiO₂), silicon nitride (SiN), silicon oxynitride (SiON), zirconium dioxide (ZrO₂), titanium dioxide (TiO₂), silicon carbide (SiC), a laminate of layers containing the same, and the like can be mentioned. The material of the diaphragm 30 is more preferably one having a Young's modulus of 250 GPa or less in terms the fact that the displacement can be increased and breakage is hard to occur. For example, the diaphragm 30 more preferably contains ZrO₂ (150 GPa), SiO₂ (75 GPa), Si (130 GPa), SUS (199 GPa), and Cr (248 GPa) (In the brackets, the Young's modulus is shown.). In the case where the electrodes of the piezoelectric element 32 are formed of Pt and are integrally laminated with the diaphragm 30, since the Young's modulus of Pt is 168 GPa and the Young's modulus of ZrO₂ is 150 GPa, the Young's modulus even when combined is 250 GPa or less. Therefore, such a configuration may be acceptable.

In this specification, the Young's modulus refers to the Young's modulus measured in a static test (JIS G0567J or the like) (Mechanical test), and for example, the Young's modulus is measured using No. II-6 specimen, for example.

The piezoelectric ink jet head 100 further has a compliance sheet 140 as a member forming a part of an ink flow passage and a cover 150 accommodating the piezoelectric element 32. The compliance sheet 140 forms the supply port 126 communicating with the ink supply chamber 40 between the compliance sheet 140 and the communication plate 110. The compliance sheet 140 is a flexible elastic film and has a function as a damper for the discharge and the flow of an ink and a function of preventing breakage of the head 100 by deformation when the volume of an ink expands.

The compliance sheet 140 is not particularly limited insofar as it is a film having elasticity. For example, a polymer film, a metal formed into a thin film, a glass fiber, a carbon fiber, and the like are used. The material of the polymer film is not particularly limited and polyimide, nylon, polyolefin, polyphenylene sulfide, and the like are mentioned. The polymer film is more preferably formed of polyphenylene sulfide. Examples of the metal include materials containing iron and aluminum, for example.

The thickness of the compliance sheet 140 is not particularly limited and is preferably 50 μm or less, more preferably 20 μm or less, and still more preferably 1 μm to 10 μm or less, for example. When the compliance sheet 140 is excessively thin, the vibration increases in discharging an ink, so that residual vibration frequently occur in some cases.

In this embodiment, the ink supply chamber 40, the supply port 126, the pressure chamber 20, and the communication opening 127 are described in distinction from each other but are all liquid flow passages. The design of the flow passage is not limited insofar as the pressure chamber 20 is formed. For example, the supply port 126 has the shape in which the flow passage is partially narrowed in the example illustrated in the figure. However, such expansion and reduction of the flow passage can be arbitrarily formed according to a design and is not necessarily an indispensable configuration.

The pressure chamber 20 formed by the above-described configuration is the space partitioned by the communication plate 110, the pressure chamber substrate 120, and the diaphragm 30 and refers to the space not containing the supply port 126, the communication opening 127, the discharge port 128, and the nozzle opening 12. More specifically, a space facing the portions (portions where the wall of the pressure chamber 20 is deformed and heat is generated) where pressure is applied to an ink, such as the diaphragm 30, the pressure chamber substrate 120, and the communication plate 110, and a space adjacent to the above-described space and having a cross-sectional area of the cross section in a direction where an ink moves equal to that of the space described above are defined as the pressure chamber 20. The capacity of the pressure chamber 20 is the capacity of the space. Thus, the pressure chamber is defined as the space where the capacity varies with displacement of the diaphragm 30 and as the space not containing the narrowed flow passage and the like communicating with the space.

As described above, the communication opening 127 communicates with the nozzle opening 12 from the pressure chamber 20. In the present invention, a portion from a portion where an ink flows out of the pressure chamber 20 to the nozzle side to the nozzle, i.e. the communication opening 127, the nozzle opening 12, and the entire portion connecting the same, is defined as the connection portion 132 in the example of FIG. 3. Therefore, the distance of the connection portion 132 is equal to the sum of a length d1 in the thickness direction of the communication plate 110 and a length d2 in the thickness direction of the nozzle plate 10 in the example of FIG. 3 because the connection portion 132 is provided so as to pass through in parallel to the thickness direction of the communication plate 110.

In this embodiment, the sum of the length d1 in the thickness direction of the communication plate 110 and the length d2 in the thickness direction of the nozzle plate 10, i.e., d1+d2, is preferably 500 μm or more, for example. Thus, due to the configuration in which the distance of the connection portion 132 is long, the progress of drying of an ink from the nozzle surface 13 can be prevented.

In the example illustrated in FIG. 3, the nozzle plate 10 and the communication plate 110 are laminated and the nozzle opening 12 and the communication opening 127 are formed of different members but the nozzle plate 10 and the communication plate 110 may be formed of a single member. Also when the nozzle plate 10 and the communication plate 110 are formed of a single member, the connection portion 132 is a portion from the portion where an ink flows out of the pressure chamber 20 to the nozzle side to the nozzle. Also in this case, when the distance of the connection portion 132 is 500 μm or more, the progress of drying of an ink from the nozzle surface 13 can be prevented.

The distance of the connection portion 132 is preferably 500 μm or more and 3000 μm or less, more preferably 700 μm or more and 2500 μm or less, and still more preferably 900 μm or more and 1500 μm or less. Also when the communication opening 127 extends obliquely to the nozzle plate 10, the length of the communication opening 127 is the length along the communication opening 127 and is longer than the length d1 in the thickness direction of the communication plate 110 in this case. More specifically, the shortest distance from the boundary between the pressure chamber 20 and the communication opening 127 to the nozzle opening 12 through the inside of the communication opening 127 is the length of the communication opening 127. The distance of the connection portion 132 is the length obtained by adding the length of the nozzle opening 12 and the entire portion connecting them to the length of the communication opening 127.

The total capacity of the pressure chamber 20 per pressure chamber 20 and the connection portion 132, i.e., the total capacity of the pressure chamber 20, the communication opening 127, and the nozzle opening 12 in this embodiment, is preferably 4200 pl or more and 6200 pl or less and more preferably 4500 pl or more and 5500 pl or less. In this case, the progress of drying of an ink from the nozzle surface 13 can be further prevented.

In this case, the capacity per pressure chamber 20 is preferably 20 is 3700 pl or less and more preferably 3500 pl or less. Furthermore, the capacity per pressure chamber is more preferably 3300 pl or less and still more preferably 3000 pl or less. The lower limit value of the capacity per pressure chamber 20 is preferably 1500 pl or more and more preferably 2000 pl or more. Due to the fact that the capacity of the pressure chamber 20 is 3700 pl or less, the capacity of the communication opening 127 can be sufficiently secured. Therefore, the progress of drying of an ink from the nozzle surface 13 can be effectively prevented.

The ink supply chamber 40 can temporarily store an ink to be supplied from the outside (for example, ink cartridge) through a through-hole 129 formed in the diaphragm 30. The ink in the ink supply chamber 40 can be supplied to the pressure chamber 20 through the supply port 126. The capacity of the pressure chamber 20 varies with the deformation of the diaphragm 30. The pressure chamber communicates with the nozzle opening 12 through the communication opening 127. Due to the variation in the capacity of the pressure chamber 20, an ink can be discharged from the nozzle opening 12 or an ink can be introduced into the pressure chamber 20 from the ink supply chamber 40. Herein, the nozzle diameter of the nozzle opening 12 is preferably 5 μm or more and 100 μm or less, more preferably 10 μm or more and 60 μm or less, and still more preferably 10 μm or more and 40 μm or less in terms of obtaining excellent image quality and reducing the intermittency and mist.

The case 130 can store the nozzle plate 10, the pressure chamber substrate 120, and the piezoelectric element 32 as illustrated in FIG. 2. As the material of the case 130, resin, metal, and the like can be mentioned, for example. The case 130 may have a function of separating the piezoelectric element 32 from the outside environment. The case 130 may be filled with inactive gas or the like or the pressure of the inside of the case 130 may be reduced. Thus, degradation and the like of the piezoelectric material can be prevented.

The cover 150 is configured as a member separated from the case 130. The cover 150 is provided in contact with the diaphragm 30, forms the space accommodating the piezoelectric element 32, and stores the piezoelectric element 32 in the space. The material of the cover 150 is the same as the material of the case 130. The case 130 serves as a cover covering the piezoelectric element 32. The cover 150 may have a function of separating the piezoelectric element 32 from the outside environment, inactive gas or the like may be charged into the space formed by the cover 150, or the pressure of the space may be reduced. Thus, degradation and the like of the piezoelectric material of the piezoelectric element 32 can be prevented. In this case, the case 130 may function as a support of the piezoelectric ink jet head 100.

When the piezoelectric ink jet head 100 described above as an example is mounted in the printer 1, the nozzle plate 10 is disposed facing a recording medium and the nozzle plate 10 directly contacts the atmosphere (open air). In this embodiment, since the piezoelectric ink jet head 100 has the case 130 and the cover 150, the piezoelectric element 32 and the diaphragm 30 are configured so as substantially not to contact the open air.

In this embodiment, the piezoelectric ink jet head 100 can perform recording using at least droplets satisfying the following formula (1) when the recording is performed by discharging the liquid droplets drop by drop from the nozzle,

0.13≦{(Discharge amount per droplet)/(Capacity of ink pressure chamber)}×100 (1).

The piezoelectric ink jet head 100 satisfying Formula (1) is likely to cause cavitation, and therefore the discharge is easily affected by the ink composition. However, by combining an ink described later, an image recording method in which poor discharge due to the occurrence of cavitation is reduced to achieve excellent discharge stability can be provided. By the use of the piezoelectric ink jet head satisfying Formula (1), good thin line representation can be achieved.

In Formula (1) above, the discharge amount per droplet is the volume flow rate. The discharge amount per droplet is approximately equivalent to the capacity reduction amount (excluded volume) of the ink pressure chamber in discharging one droplet due to the displacement of the diaphragm. In Formula (1) above, the one droplet refers to one liquid droplet when the liquid is discharged from the piezoelectric ink jet head 100 and does not include a gathering of a plurality of liquid droplets before landing on the surface of a recording medium.

In Formula (1) above, the capacity of the ink pressure chamber is the total capacity of the space facing the portion where pressure is applied to an ink and the space adjacent to the space described above and in a direction where an ink moves to the nozzle. More specifically, the capacity of the ink pressure chamber is the total capacity of the space where the capacity varies with the displacement of the diaphragm and the space containing the narrowed flow passage communicating with the space described above and the like. Therefore, in this embodiment, the capacity of the ink pressure chamber is the total capacity of the pressure chamber per pressure chamber and the connection portion, i.e., the total capacity of the pressure chamber 20, the communication opening 127, and the nozzle opening 12, is the capacity of the ink pressure chamber.

In this embodiment, the piezoelectric ink jet head 100 may satisfy the following formula (2),

0.13≦{(Discharge amount per droplet)/(Capacity of ink pressure chamber)}×100≦0.18 (2).

In this embodiment, also in the case of the piezoelectric ink jet head satisfying Formula (2), by combining an ink described later, an image recording method in which poor discharge due to the occurrence of cavitation is reduced to achieve excellent discharge stability can be provided.

### 1.1.2. Arrangement of Each Unit

Next, the printer 1 which is an example of this embodiment is described in more detail with reference to FIG. 4. In FIG. 4 for use in the following description, the scale of each member is altered as appropriate so that each member can be recognized.

FIG. 4 is a schematic cross sectional view illustrating the periphery of the transporting unit 200, the head unit 300, and the irradiation unit 400 in the printer 1 of FIG. 1.

In this embodiment, the transporting unit 200 has an upstream roller 250A, a downstream roller 250B, a transporting drum 260 transporting a long recording medium S rolled in a roll shape with the peripheral surface, irradiation portions for temporary curing 420a, 420b, 420c, and 420d, and an irradiation portion for complete curing 440. This embodiment is configured so that the transporting roller containing the upstream roller 250A and the downstream roller 250B rotate by a transporting motor (not illustrated) and the transporting drum 260 follows the rotation. Then, the recording medium S is transported with the rotation of the transporting rollers 250A and 250B along the peripheral surface of the transporting rollers 250A and 250B and the transporting drum 260 which is a support. Around the transporting drum 260, each line head containing a head K, a head C, a head M, and a head Y is disposed facing the transporting drum 260. By such a configuration, the printer 1 performs image recording by a discharge operation of discharging and attaching an ink to the recording medium S facing each line head as described later.

In FIG. 4, the transporting drum 260 has a surface where the recording medium S is transported, supports the recording medium S, and moves relatively to the heads to pass through a position facing each line head. When the transporting drum 260 moves relatively to the heads while supporting the recording medium S, the time (cycle) until the transporting drum 260 returns to the same position from an arbitrary position is preferably 5 seconds or more and more preferably 6 seconds. When the time falls within the ranges mentioned above, a temperature increase due to heat dissipation of the transporting drum 260 can be prevented. The upper limit of the cycle is not particularly limited and may be within 15 seconds, for example, in order to realize high-speed printing.

The movement with the predetermined cycle by the transporting drum 260 may be performed at least while image recording is performed and may be continuously or intermittently performed while image recording is performed.

The shape of the transporting drum 260 is not limited to the support of a drum shape as illustrated in FIG. 4 and supports of a drum shape, a roller shape, and a belt shape and a plate-shaped support (platen or the like) supporting the recording medium S are also preferably mentioned, for example, but the shape is not limited thereto. The movement of the transporting drum 260 performed relatively to the heads may also be movement in which the transporting drum 260 moves (rotates) in one direction to return to the same position or movement in which the transporting drum 260 returns to the same position by moving in a certain direction and moving in another direction. In the latter case, an aspect is mentioned in which the movement in a certain direction is movement associated with recording on one recording medium of a cut sheet type and the movement in another direction is movement for performing recording on the following recording medium after finishing the recording on one recording medium. In the case of a serial printer, the movement in a certain direction is equivalent to subscanning.

Examples of the material of the transporting drum 260 include, but are not limited thereto, metal, resin, and rubber, for example, and metal is particularly preferable. In the case where the material is metal, even when the transporting drum 260 is used over a long period of time, cracking considered to be degradation due to heat does not occur, so that long-term use can be achieved, unlike the case where the material is a polymer material, such as rubber. Examples of the metal include, but are not limited thereto, aluminum, stainless steel, copper, iron, and alloys thereof, for example. Furthermore, the surface of the metal transporting drum 260, i.e., the transporting surface of the recording medium S, may be coated with a coating agent or the like. Thus, the hardness of the surface of the transporting drum 260 can be increased as compared with the surface of the transporting drum 260 which is not coated and slipping can be made difficult to occur between the transporting drum 260 and the recording medium S. Examples of the coating agent include, but are not limited thereto, organic coating agents, such as resin, and inorganic coating agents, such as inorganic compounds, and composite coating agents thereof, for example. The matter about the transporting drum 260 described above is applicable not only to a line printer but a serial printer.

In this embodiment, the irradiation unit 400 has the irradiation portions for temporary curing 420a, 420b, 420c, and 420d and the irradiation portion for complete curing 440, and each irradiation portion has an LED as a light source for the irradiation, for example. In the LED, by controlling the size of an input current, the irradiation energy can be easily varied.

The irradiation portion for complete curing 440 emits radiation for performing complete curing of dots formed on a recording medium. The irradiation portion for complete curing 440 is provided on the downstream side in the transporting direction relative to the fourth irradiation portion 420d of the irradiation portions for temporary curing 420. More specifically, the irradiation portion for complete curing 440 is provided at a place distant from each head of the head unit 300. The length in the recording medium width direction of the irradiation portion for complete curing 440 is equal to or larger than the recording medium width. The irradiation portion for complete curing 440 emits radiation for complete curing (for example, UV) to dots formed by each head of the head unit 300. The irradiation portion 440 for complete curing of this embodiment may be configured so to as to have, as the light source, a lamp (a metal halide lamp, a xenon lamp, a carbon arc light, a chemical lamp, a low-pressure mercury lamp, a high-pressure mercury lamp, or the like). In this embodiment, each irradiation portion may be configured so as to have a plurality of prisms.

### 1.1.3. Deaeration Unit

In this embodiment, the printer 1 may be configured so as to further have an ink deaeration unit (not illustrated).

Until an ink is supplied to each piezoelectric ink jet head 100 of the line head, air bubbles or oxygen sometimes enter/enters an ink through an ink pack or members of a feeding unit during long-term storage of an ink container and in the feeding unit. Then, when the printer 1 has the deaeration unit (not illustrated), deaeration is performed which includes removing air bubbles and gas, such as oxygen, from the ink in the printer 1, whereby the dissolved oxygen concentration of the ink is reduced and the occurrence of cavitation in the head is prevented, so that the discharge stability is improved. In this embodiment, the line head is used and the ink use amount is large. Therefore, when the deaeration unit is provided, the discharge stability is improved.

The deaeration unit is configured so as to have a deaeration chamber into which an ink flows and a pressure reducing chamber contacting the deaeration chamber through a separation film, such as a hollow fiber film, which allows the passing of gas, such as air, but does not allow the passing of liquid, such as ink, and deaerates an ink by reducing the pressure of the pressure reducing chamber by a pressure reducing pump, for example. The deaeration unit is preferably provided between an ink container and an ink path of the head in terms of deaeration efficiency. The deaeration unit is preferably a pressure reducing deaeration unit having a pressure reducing unit, such as a pump, in terms of deaeration efficiency and may have a stirring unit or an irradiation unit performing stirring and emission of ultrasonic waves in pressure reduction.

The deaeration unit may be a warming unit warming an ink besides the pressure reducing unit. As the warming unit, known warming units, such as a heater, are usable.

Herein, according to the image recording method of this embodiment, an image is recorded using an ink composition described later in the ink jet recording apparatus described above.

### 1.2. Ink Jet Ink Composition

An ink jet ink composition for use in an image recording method according to one embodiment of the present invention is used for the image recording method according to this embodiment.

Hereinafter, components contained in the ink jet ink composition (hereinafter also simply referred to as “ink”) for use in the image recording method according to this embodiment are described taking a radiation curing type ink jet ink composition as an example of the ink jet ink composition. An ink usable in this embodiment is not limited to the radiation curing type ink jet ink composition and may be an aqueous ink jet ink composition and a solvent-based ink jet ink composition.

Herein, the aqueous ink jet ink composition refers to an ink which is a composition containing water as the main component as a solvent component and in which the content of water contained in the ink is 50% by mass or more based on the total ink mass. The solvent-based ink jet ink composition refers to an ink which is a composition containing a solvent, such as an organic solvent, as the main component and not containing water as the main component as a solvent component and in which the content of the solvent, such as an organic solvent, is 80% by mass or more.

As one embodiment of the “radiation curing type”, an “ultraviolet curing type”, a “photocurable type”, and the like are described in some cases. In this embodiment, the composition may be a radiation curing type composition which is cured by emitting radiation for use and may be replaced with an ultraviolet curing type composition and the ultraviolet curing type composition may be replaced with a radiation curing type composition or a radiation curing type composition. Examples of the radiation include ultraviolet rays, infrared rays, visible light, X-rays, and the like. As the radiation, ultraviolet rays are preferable in terms of the fact that a radiation source is easily available and widely used and materials suitable for curing by emission of ultraviolet rays are easily available and widely used.

In this embodiment, the “radiation curing type ink jet ink composition” is an ink jet ink composition for use in an ink jet recording method having a curing process of emitting active radiation to a radiation curing type ink jet ink composition adhering to a recording medium to obtain a cured film and known substances can be used.

The radiation curing type ink jet ink composition for use in one embodiment of the present invention contains a pigment, a monomer (polymerizable compound) forming an ink coating, a photopolymerization initiator, and an organic solvent, for example. Hereinafter, components contained in the radiation curing type ink jet ink composition and components which may be contained therein are described in detail.

### 1.2.1. Pigment

The ink jet ink composition for use in the image recording method according to this embodiment contains a pigment having a maximum particle size of 2.5 μm or less. By the use of the ink jet ink composition containing the pigment having a maximum particle size of 2.5 μm or less, an image recording method in which poor discharge is reduced to achieve excellent discharge stability is obtained even in recording with continuous scanning time of 10 minutes or more.

As the pigment, both inorganic pigments and organic pigments are usable insofar as the maximum particle size is 2.5 μm or less.

As the inorganic pigments, carbon black (C.I. Pigment Black 7), such as furnace black, lamp black, acetylene black, and channel black, iron oxide, and titanium oxide are usable.

Examples of the organic pigments include azo pigments, such as an insoluble azo pigment, a condensed azo pigment, an azo lake pigment, and a chelate azo pigment, polycyclic pigments, such as a phthalocyanine pigment, perylene and perinone pigments, an anthraquinone pigment, a quinacridone pigment, a dioxane pigment, a thioindigo pigment, an isoindolinone pigment, and a quinophthalone pigment, dye chelates (for example, basic dye chelate, acidic dye chelate, and the like), color lakes (basic dye lake, and acidic dye lake), a nitropigment, a nitroso pigment, aniline black, and a daylight fluorescent pigment.

More specifically, examples of the carbon black for use in a black composition include, but are not particularly limited thereto, No. 2300, No. 900, MCF88, No. 33, No. 40, No. 45, No. 52, MA7, MA8, MA100, No. 2200B, and the like (all manufactured by Mitsubishi Chemical Corporation), Raven 5750, Raven 5250, Raven 5000, Raven 3500, Raven 1255, Raven 700, and the like (all manufactured by Carbon Columbia), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (all manufactured by CABOT JAPAN K. K.), Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all manufactured by Degussa).

Pigments for use in a white composition include, but are not particularly limited thereto, C.I. Pigment White 6, 18, and 21, for example.

Pigments for use in a yellow composition include, but are not particularly limited thereto, C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180, for example.

Pigments for use in a magenta composition include, but are not particularly limited thereto, C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), (Ca), 57:1, 88, 112, 114, 122, 123, 144, 146, 149, 150, 166, 168, 170, 171, 175, 176, 177, 178, 179, 184, 185, 187, 202, 209, 219, 224, and 245 or C.I. Pigment Violet 19, 23, 32, 33, 36, 38, 43, and 50, for example.

Pigments for use in a cyan composition include, but are not particularly limited thereto, C.I. Pigment Blue 1, 2, 3, 15, 15:1, 15:2, 15:3, 15:34, 15:4, 16, 18, 22, 25, 60, 65, and 66, and C.I. Vat Blue 4 and 60, for example.

Pigments for use in compositions other than the magenta, cyan, and yellow compositions include, but are not particularly limited thereto, C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63, for example.

The pigments mentioned above may be used alone or in combination of two or more kinds thereof.

When the pigments mentioned above are used, the maximum particle size of the pigments is preferably 2.5 μm or less, more preferably 2.0 μm or less, still more preferably 1.7 μm or less, and yet still more preferably 1.5 μm or less. In this embodiment, due to the fact that the maximum particle size of the pigments is 2.5 μm or less, the accumulation of coarse particles and the occurrence of cavitation in the head are prevented even in recording with continuous scanning time of 10 minutes or more, so that an image recording method in which poor discharge, such as clogging, is reduced to achieve excellent discharge stability is obtained.

Herein, in this specification, the maximum particle size of the pigment means the maximum particle size of coarsened particles resulting from flocculation or bonding of primary particles of the pigment and is different from the average particle size of the primary particles of the pigment. The maximum particle size can be measured using a particle size distribution meter of a number count system, AccuSizer (manufactured by PSS Japan), which is a device capable of measuring the state of coarse particles, such as flocculated particles, for example.

In this specification, the primary particle is the minimum unit of particles dispersed without flocculation in an ink. More specifically, the primary particles are not limited to single crystals or crystallites. In this embodiment, the maximum particle size of the pigment refers to the maximum particle size value of the pigment particles present exceeding 400 particles/20 ml in the particle size distribution meter.

A method for measuring the maximum particle size is not limited to the following method and, for example, the measurement can be performed by diluting an ink sample to the concentration suitable for the measurement using a solvent suitable for the measurement and using a device of a number count system by a light shielding method. For example, an ink sample is diluted with EDGAC (ethyldiglycolacetate) to 3000 times, 20 ml of the diluted sample is charged into AccuSizer 780APS (manufactured by PSS Japan), and then the measurement can be performed under the following conditions.

### AccuSizer Conditions

Injected sample amount: 20 ml
Flow velocity: 1 ml/s
Number of channels: 128
Measurement principle: Number count system by light shielding method
Definition of maximum particle size: The size when the number of coarse particles exceeds 400 particles/20 ml is defined as the maximum particle size.

The pigment can have an aspect ratio of the primary particles of 2.5 or more and an average particle size (D50) of the primary particles of the pigment of 170 nm or more. Examples of such a pigment include pigments which are likely to take a rectangular shape, such as C.I. Pigment Yellow 155, C.I. Pigment Yellow 128, and C.I. Pigment Red 122, for example. In C.I. Pigment Yellow 155 used in Examples of this specification described later, the aspect ratio of the primary particles is 4.5 and the average particle size (D50) of the primary particles is 235 nm.

Herein, in this specification, the aspect ratio of the primary particles of the pigment is the average aspect ratio of the primary particles of each pigment calculated by the ratio of (Length of major axis)/(Length of minor axis).

Specifically, pigment powder is observed under a TEM (transmission electron microscope) or a SEM (scanning electron microscope), and then an image of each pigment particle is obtained. Then, the particle size (diameter) at an interval of 1° in the angle range of 0 to 179° from the center of gravity of the obtained image of each pigment particle is measured, and then the maximum value of the particle sizes of the measured 180 particles is defined as the length of the major axis and the minimum value is defined as the length of the minor axis, whereby the aspect ratio of the primary particles of each pigment is obtained. For the average aspect ratio, the average aspect ratio of 50 or more pigment particles thus obtained is used.

In this specification, the average particle size (D50) of the primary particles of pigment means the cumulative 50% volume average particle size (D50) on a volume basis by a dynamic light scattering method and is a value obtained as follows. Particles in a dispersion medium are irradiated with light, and then the generated diffracting and scattering light is measured with detectors disposed on the front, the sides, and the behind of the dispersion medium. On the assumption that the particles which originally have an indefinite shape have a spherical shape, the cumulative curve is obtained using the measured value by setting the total volume of the particle group converted into a ball having a volume equal to the volume of the particles to 100%. Then, the point when the cumulative value at that time is 50% is defined as the 50% average particle size (D50).

With respect to a pigment having an aspect ratio of the primary particles within the range of 1.0 or more and less than 2.5, the shape of the pigment particles has a pseudosphere shape. Therefore, the interaction (flocculation attraction) between the pigments decreases, so that the occurrence of discharge instability due to the flocculation in a nozzle can be prevented. The pigment is stably dispersed in an ink, and therefore an increase in the ink viscosity due to the flocculation of the pigment is prevented, so that the storage stability and the discharge stability of an ink are excellent. When the average particle size (D50) of the primary particles of the pigment is less than 170 nm, the coarsening of particles due to the flocculation of the pigment is hard to occur.

On the other hand, a pigment having a rectangular shape having an aspect ratio of the primary particles of the pigment of 2.5 or more and an average particle size (D50) of the primary particles of 170 nm or more has high interaction between the pigments, and therefore the pigment is difficult to be dispersed, so that the particles are easily coarsened due to the flocculation and the like. In this embodiment, even in the case of using such a pigment which is likely to be coarsened, an image recording method in which poor discharge is reduced to achieve more excellent discharge stability can be provided by controlling the maximum particle size of the coarsened particles to be 2.5 μm or less.

In order to set the maximum particle size of the coarsened particles to 2.5 μm or less, a filter having a pore size of 1.5 μm or less is used or centrifugal separation or the like is performed in filter filtration in the preparation of an ink. In order to increase the dispersibility of an ink, a dispersant is used or ultrasonic waves are emitted, for example, in the preparation of an ink.

In this embodiment, the addition amount of the pigment which can be added to the radiation curing type ink jet ink composition is 0.1% by mass or more and 25% by mass or less and more preferably 0.5% by mass or more and 15% by mass or less based on the total mass of the radiation curing type ink jet ink composition.

Not only the pigment but dyes can also be used in combination as the coloring material. As the dye, acidic dye, direct dye, reactive dye, and basic dye can be used without being particularly limited.

### 1.2.2. Polymerizable Compound (Monomer)

The radiation curing type ink jet ink composition contains a polymerizable compound. The polymerizable compound is polymerized independently or by the action of a photopolymerization initiator when light is emitted to be able to cure an ink on a recording medium. The polymerizable compound is not particularly limited and, specifically, known monofunctional monomers, bifunctional monomers, and trifunctional or higher polyfunctional monomers and oligomers are usable. The polymerizable compounds may be used alone or in combination of two or more kinds thereof. Hereinafter, examples of these polymerizable compounds are mentioned.

Examples of the monofunctional, bifunctional, and trifunctional or higher polyfunctional monomers and oligomers, include, but are not particularly limited thereto, unsaturated carboxylic acids, such as (meth) acrylic acid, itaconic acid, crotonic acid, isocrotonic acid, and maleic acid; salts of the unsaturated carboxylic acids; esters, urethanes, amides, and anhydrides of the unsaturated carboxylic acids; acrylonitrile, styrene, various unsaturated polyesters, unsaturated polyethers, unsaturated polyamides, and unsaturated urethanes, for example. Examples of the monofunctional, bifunctional, and trifunctional or higher polyfunctional oligomers include, but are not particularly limited thereto, oligomers formed from the monomers mentioned above, such as linear acryl oligomers, epoxy (meth)acrylate, oxetane (meth)acrylate, aliphatic urethane (meth)acrylate, aromatic urethane (meth)acrylate, and polyester (meth)acrylate, for example.

In this specification, the epoxy (meth)acrylate refers to a compound obtained by causing unsaturated carboxylic acid and an epoxy compound to react with each other. In this reaction, the epoxy compound causes an ester bond with the unsaturated carboxylic acid through ring opening of the epoxy group of the epoxy compound, whereby the epoxy compound and the unsaturated carboxylic acid are bonded to each other. The “(meth)acrylate” means at least any one of acrylates or methacrylates corresponding to the acrylates. The “(meth) acryl” means at least any one of acryl and methacryl corresponding to the acryl.

As the other monofunctional monomers and polyfunctional monomers, N-vinyl compounds may be included. Examples of the N-vinyl compounds include, but are not particularly limited thereto, N-vinyl formamide, N-vinyl carbazole, N-vinyl acetamide, N-vinyl pyrrolidone, N-vinyl caprolactam, acryloyl morpholine, and derivatives thereof, for example.

Examples of the monofunctional (meth)acrylate include, but are not particularly limited thereto, isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, lactone-modified flexible (meth)acrylate, t-butylcyclohexyl (meth)acrylate, dicyclopentanyl (meth)acrylate, and dicyclopentenyloxyethyl (meth)acrylate, for example. Among the above, phenoxyethyl (meth)acrylate is preferable.

As the monofunctional (meth)acrylate, monofunctional (meth)acrylate having an aromatic ring skeleton is preferably contained. As the monofunctional (meth)acrylate having an aromatic ring skeleton, monofunctional (meth)acrylate containing a vinyl ether machine represented by Formula (I) is excluded.

The monofunctional (meth)acrylate having an aromatic ring skeleton is a compound having an aromatic ring skeleton and having a (meth)acryloyl group in one molecule as a polymerizable functional group. Examples of the monofunctional (meth)acrylate having an aromatic ring skeleton include, but are not particularly limited thereto, benzyl (meth)acrylate, phenoxyethyl (meth)acrylate (PEA), alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate, for example. Examples of commercially-available items thereof include Viscoat #192 (manufactured by Osaka Organic Chemical Industry Co., Ltd., Trade name, phenoxyethyl acrylate), SR340 (phenoxyethyl methacrylate), SR339A (phenoxyethyl acrylate), SR504 (ethoxylated nonylphenyl acrylate), CD614 (alkoxylated nonylphenyl acrylate), and CD9087 (alkoxylated 2-phenoxyethyl acrylate) (all manufactured by Sartomer, Trade name).

Among the above, at least any one of compounds represented by the following general formula (II) and compounds represented by the following general formula (III) are preferable.

CH₂═CR⁴—COOR⁵—Ar (II)

CH₂═CR⁴—COO—Ar (III)

In Formula (II) and (III) above, R⁴ is a hydrogen atom or a methyl group. In Formula (II) above, Ar representing an aromatic ring skeleton is a monovalent organic residue which has at least one aryl group and in which a carbon atom configuring the aryl group is bonded to a group represented by R⁵, and R⁵ is a divalent organic residue having 1 to 4 carbon atoms. In Formula (III) above, Ar representing an aromatic ring skeleton is a monovalent organic residue which has at least one aryl group and in which a carbon atom configuring the aryl group is bonded to —COO— in Formula (III).

In General Formula (II) above, as examples of the group represented by R⁵, linear, branched, or cyclic alkylene groups having 1 to 4 carbon atoms which may be substituted and alkylene groups having 1 to 4 carbon atoms which may be substituted and has an oxygen atom through an ether bond and/or an ester bond in the structure are preferably mentioned. Among the above, alkylene groups having 1 to 4 carbon atoms, such as an ethylene group, an n-propylene group, an isopropylene group, and a butylene group, and alkylene groups having 1 to 4 carbon atoms having an oxygen atom through an ether bond in the structure, such as an oxyethylene group, an oxy n-propylene group, an oxyisopropylene group, and an oxybutylene group are preferably mentioned. When the organic residue is a group which may be substituted, examples of substituents include, but are not particularly limited thereto, a carboxyl group, an alkoxy group, a hydroxyl group, and a halo group, for example. When the substituent is a group containing a carbon atom, the carbon atom is counted into the number of carbons of the organic residue.

In General Formulae (II) and (III) above, examples of the at least one aryl group contained in Ar (aryl) (aromatic ring skeleton) include, but are not limited thereto, a phenyl group and a naphthyl group, for example. The number of the aryl groups is 1 or more and preferably 1 or 2. The aryl group may be substituted by carbon atoms other than the carbon atoms bonded to the organic residue represented by R⁵ in Formula (II), the carbon atom bonded to —COO— in Formula (III), and, when a plurality of aryl groups are contained, the carbon atom bonding the aryl groups, among the carbon atoms configuring the group. When substituted, the number of substitutions per aryl group is 1 or more and preferably 1 or 2. Examples of the substituents include, but are not particularly limited thereto, linear, branched, or cyclic alkyl groups and alkoxy groups having 1 to 10 carbon atoms, a carboxyl groups, a halo group, and a hydroxyl group, for example.

Due to the fact that the monofunctional (meth)acrylate having an aromatic ring skeleton is contained, the solubility of a photopolymerization initiator described later tends to be improved and the curability tends to be improved, and therefore it is preferable to contain the monofunctional (meth)acrylate. In particular, when an acylphosphine oxide-based photopolymerization initiator and a thioxanthone-based photopolymerization initiator are used, the solubility tends to be improved. Among the monofunctional (meth)acrylates having an aromatic ring skeleton, phenoxyethyl (meth)acrylate and benzyl (meth)acrylate are preferable and phenoxyethyl (meth)acrylate is more preferable because malodor is lower.

The content of the monofunctional (meth)acrylate is preferably 30% by mass or more and 85% by mass or less and more preferably 40% by mass or more and 75% by mass or less based on the total mass (100% by mass) of the radiation curing type ink jet ink composition. By setting the content in the preferable ranges mentioned above, the curability, the initiator solubility, the storage stability, and the discharge stability are excellent.

Examples of the monofunctional (meth)acrylate include those containing a vinyl ether group. Examples of such a monofunctional (meth)acrylate include, but are not particularly limited thereto, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate and polypropylene glycol monovinyl ether (meth)acrylate, phenoxyethyl (meth)acrylate, isobonyl (meth)acrylate, and benzyl (meth)acrylate, for example. Among the above, 2-(vinyloxyethoxy)ethyl (meth)acrylate, phenoxyethyl (meth)acrylate, isobonyl (meth)acrylate, and benzyl (meth)acrylate are preferable.

As the monofunctional (meth)acrylate containing a vinyl ether group, compounds represented by the following general formula (I) are preferably contained.

CH₂═CR¹—COOR²—O—CH═CH—R³ (I)

In Formula (I), R¹ is a hydrogen atom or a methyl group, R² is a divalent organic residue having 2 to 20 carbon atoms, and R³ is a hydrogen atom or a monovalent organic residue having 1 to 11 carbon atoms.

The vinyl ether group containing (meth)acrylate represented by General Formula (I) is sometimes simply referred to as “Compound of Formula (I)”.

Due to the fact that the composition according to this embodiment contains the compound of Formula (I), the curability of the composition can be made excellent. Moreover, due to the fact that the compound of Formula (I) is contained, the viscosity of the composition is easily kept low. It is more preferable to use a compound having both a vinyl ether group and a (meth)acryl group in one molecule than to separately use a compound having a (meth)acryl group and a compound having a vinyl ether group in terms of improving the curability of the composition.

In General Formula (I) above, as the divalent organic residue having 2 to 20 carbon atoms represented by R², a linear, branched, or cyclic alkylene group having 2 to 20 carbon atoms which may be substituted, an alkylene group having 2 to 20 carbon atoms which may be substituted and has an oxygen atom through an ether bond and/or an ester bond in the structure, and a divalent aromatic group having 6 to 11 carbon atoms which may be substituted are preferable. Among the above, alkylene groups having 2 to 6 carbon atoms, such as an ethylene group, an n-propylene group, an isopropylene group, and a butylene group, and alkylene groups having 2 to 9 carbon atoms and having an oxygen atom through an ether bond and/or an ester bond in the structure, such as an oxyethylene group, an oxy n-propylene group, an oxyisopropylene group, and an oxybutylene group, are preferably used. Furthermore, compounds having a glycol ether chain in which R² is an alkylene group having 2 to 9 carbon atoms and having an oxygen atom through an ether bond in the structure, such as an oxyethylene group, an oxy n-propylene group, an oxyisopropylene group, and an oxybutylene group, are more preferable from the viewpoint that the viscosity of the radiation curing type ink jet composition can be further reduced and the curability thereof can be further improved.

In General Formula (I) above, as the monovalent organic residue having 1 to 11 carbon atoms represented by R³, a linear, branched, or cyclic alkyl group having 1 to 10 carbon atoms which may be substituted and an aromatic group having 6 to 11 carbon atoms which may be substituted are preferable. Among the above, an alkyl group having 1 to 2 carbon atoms which is a methyl group or an ethyl group and an aromatic group having 6 to 8 carbon atoms, such as a phenyl group and a benzyl group, are preferably used.

When each organic residue is a group which may be substituted, the substituents are classified into a group containing a carbon atom and a group not containing a carbon atom. First, when the substituent is the group containing a carbon atom, the carbon atom is counted into the number of carbons of the organic residue. Examples of the group containing a carbon atom include, but are not particularly limited thereto, a carboxyl group and an alkoxy group, for example. Examples of the group not containing a carbon atom include, but are not limited thereto, a hydroxyl group and a halo group, for example.

The content of the compound of Formula (I) is preferably 1% by mass or more and 50% by mass or less, more preferably 5% by mass or more and 40% by mass or less, still more preferably 10% by mass or more and 30% by mass or less, and particularly preferably 10% by mass or more and 25% by mass or less based on the total mass (100% by mass) of the composition. When the content of the compound of Formula (I) is 1% by mass or more, the viscosity of the composition can be reduced and the curability of the composition can be made more excellent. On the other hand, when the content is 50% by mass or less, the storage stability of an ink can be maintained in an excellent state.

Specific examples of the compound of Formula (I) include, but are not particularly limited thereto, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate (VEEA), 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate, for example.

Among the above, 2-(vinyloxyethoxy)ethyl (meth)acrylate, i.e., at least any one of 2-(vinyloxyethoxy)ethyl acrylate and 2-(vinyloxyethoxy)ethyl methacrylate, is preferable, and 2-(vinyloxyethoxy)ethyl acrylate is more preferable because the viscosity of the radiation curing type ink jet ink composition can be further reduced, the flash point is high, and the curability of the ink jet composition is excellent. Both 2-(vinyloxyethoxy)ethyl acrylate and 2-(vinyloxyethoxy)ethyl methacrylate have simple structures and have small molecular weights, and therefore can noticeably reduce the viscosity of the radiation curing type ink jet ink composition. Examples of the 2-(vinyloxyethoxy)ethyl (meth)acrylate include 2-(2-vinyloxyethoxy)ethyl (meth)acrylate and 2-(1-vinyloxyethoxy)ethyl (meth)acrylate. Examples of the 2-(vinyloxyethoxy)ethyl acrylate include 2-(2-vinyloxyethoxy)ethyl acrylate and 2-(1-vinyloxyethoxy)ethyl acrylate. 2-(vinyloxyethoxy)ethyl acrylate is more excellent than 2-(vinyloxyethoxy)ethyl methacrylate in terms of curability.

The content of the vinyl ether group containing (meth)acrylate ester, particularly 2-(vinyloxyethoxy)ethyl (meth)acrylate, is preferably 10% by mass or more and 70% by mass or less and more preferably 30% by mass or more and 50% by mass or less based on the total mass (100% by mass) of the radiation curing type ink jet ink composition. Due to the fact that the content is 10% by mass or more, the viscosity of the radiation curing type ink jet ink composition can be reduced and the curability of the radiation curing type ink jet ink composition is more excellent. On the other hand, due to the fact that the content is 70% by mass or less, the storageability of the ink jet composition is more excellent and the surface gloss of recorded matter is more excellent.

Examples of bifunctional (meth)acrylates among the (meth)acrylates above include, but are not particularly limited thereto, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentylglycol di(meth)acrylate, dimethylol tricyclodecane di(meth)acrylate, EO(ethylene oxide)adduct di(meth)acrylate of bisphenol A, PO(propylene oxide) adduct di(meth)acrylate of bisphenol A, neopentylglycol hydroxypivalate di(meth)acrylate, polytetramethylene glycol di(meth)acrylate, diethylene glycol di(meth)acrylate, and triethylene glycol di(meth)acrylate, and trifunctional or higher (meth)acrylates having a pentaerythritol skeleton or a dipentaerythritol skeleton, for example. Among the above, dipropylene glycol di(meth)acrylate is preferable. Among the above, dipropylene glycol di(meth)acrylate, tripropylene glycol di(meth)acrylate, diethylene glycol di(meth)acrylate, triethylene glycol di(meth)acrylate, and trifunctional or higher (meth)acrylates having a pentaerythritol skeleton or a dipentaerythritol skeleton are preferable. It is more preferable for the radiation curing type ink jet ink composition to contain the polyfunctional (meth)acrylate in addition to the monofunctional (meth)acrylate.

The content of the bifunctional or higher polyfunctional (meth)acrylate is preferably 5% by mass or more and 60% by mass or less, more preferably 15% by mass or more and 60% by mass or less, and still more preferably 20% by mass or more and 50% by mass or less based on the total mass (100% by mass) of the radiation curing type ink jet ink composition. By setting the content in the preferable ranges mentioned above, the curability, the storage stability, the discharge stability, and the surface gloss of recorded matter are more excellent.

Among the (meth)acrylates, examples of trifunctional or higher polyfunctional (meth)acrylates include, but are not particularly limited thereto, trimethylolpropane tri(meth)acrylate, EO-modified trimethylolpropane tri(meth)acrylate, pentaerythritol (meth)acrylate, pentaerythritol tetra(meth)acrylate, dipentaerythritol hexa(meth)acrylate, ditrimethylolpropane tetra(meth)acrylate, glycerolpropoxy tri(meth)acrylate, caprolactone-modified trimethylolpropane tri(meth)acrylate, pentaerythritolethoxy tetra(meth)acrylate, and caprolactam-modified dipentaerythritol hexa(meth)acrylate, for example.

Among the above, it is preferable for the polymerizable compound to contain the monofunctional (meth)acrylate. In this case, the viscosity of the radiation curing type ink jet ink composition is low, the solubility of a photopolymerization initiator and other additives is excellent, and the discharge stability in ink jet recording is easily obtained. Furthermore, the toughness, the heat resistance, and the chemical resistance of a cured film increase, and therefore it is more preferable to use the monofunctional (meth)acrylate and the bifunctional (meth)acrylate in combination. In particular, it is more preferable to use phenoxyethyl (meth)acrylate and dipropylene glycol di(meth)acrylate in combination.

The content of the polymerizable compound is preferably 5% by mass or more and 95% by mass or less and more preferably 15% by mass or more and 90% by mass or less based on the total mass (100% by mass) of the radiation curing type ink jet ink composition. Due to the fact that the content of the polymerizable compound falls under the ranges mentioned above, the viscosity and malodor can be reduced and the solubility and the reactivity of a photopolymerization initiator and the surface gloss of recorded matter can be made more excellent.

### 1.2.3. Photopolymerization Initiator

The radiation curing type ink jet ink composition may contain a photopolymerization initiator. The photopolymerization initiator is not particularly limited insofar as active species, such as radical and cation, are generated by emitting active radiation, so that the polymerization reaction of the monomers described above is initiated. As the photopolymerization initiator, a photoradical polymerization initiator and a photocationic polymerization initiator are usable but a photoradical polymerization initiator is preferably used.

By the use of ultraviolet rays (UV) among radiation, the safety is excellent and the cost of an irradiation portion can be suppressed. Therefore, it is preferable for the photopolymerization initiator to have an absorption peak in the ultraviolet range.

Examples of the photoradical polymerization initiator include, for example, aromatic ketones, an acylphosphine oxide compound, an aromatic onium salt compound, an organic peroxide, a thio compound (a thioxanthone compound and a thiophenyl group containing compound), a hexaaryl bimidazole compound, a ketoxime ester compound, a borate compound, an azinium compound, a metallocene compound, an active ester compound, a compound having a carbon-halogen bond, and an alkylamine compound.

Among the above, at least one kind selected from an acylphosphine oxide compound and a thioxanthone compound is preferable and it is more preferable to use an acylphosphine oxide compound and a thioxanthone compound in combination from the viewpoint of the fact that advantageous effects that the solubility in a monomer and the curability are good are obtained.

Specific examples of the photoradical polymerization initiator include acetophenone, acetophenone benzyl ketal, 1-hydroxy cyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's Ketone, benzoinpropylether, benzoinethylether, benzyl dimethyl ketal, 1-(4-isopropylphenyl)-2-hydroxy-2-methylpropane-1-one, 2-hydroxy-2-methyl-1-phenyl propane-1-one, thioxanthone, diethylthioxanthone, 2-isopropylthioxanthone, 2-chlorothioxanthone, 2-methyl-1-[4-(methylthio)phenyl]-2-morpholino-propane-1-one, bis(2,4,6-trimethylbenzoyl)-phenyl phosphine oxide, 2,4,6-trimethylbenzoyl-diphenyl-phosphine oxide, 2,4-diethylthioxanthone, and bis-(2,6-dimethoxybenzoyl)-2,4,4-trimethylpentyl phosphine oxide.

Examples of commercially-available items of the photoradical polymerization initiator include, for example IRGACURE 651 (2,2-dimethoxy-1,2-diphenylethane-1-one), IRGACURE 184 (1-hydroxy-cyclohexyl-phenyl-ketone), DAROCUR 1173 (2-hydroxy-2-methyl-1-phenyl-propane-1-one), IRGACURE 2959 (1-[4-(2-hydroxyethoxy)-phenyl]-2-hydroxy-2-methyl-1-propane-1-one), IRGACURE 127 (2-hydroxy-1-{4-[4-(2-hydroxy-2-methyl-propionyl)-benzyl]phenyl}-2-methyl-propane-1-one), IRGACURE 907 (2-methyl-1-(4-methylthiophenyl)-2-morpholino propane-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenyl phosphine oxide), IRGACURE 784 (bis(η5-2,4-cyclopentadiene-1-yl)-bis(2,6-difluoro-3-(1H-pyrrole-1-yl)-phenyl)titanium), IRGACURE OXE 01 (1.2-octanedione, 1-[4-(phenylthio)-,2-(O-benzoyloxime)]), IRGACURE OXE 02(ethanone, 1-[9-ethyl-6-(2-methylbenzoyl)-9H-carbazole-3-yl]-,1-(O-acetyloxime)), IRGACURE 754 (mixture of oxyphenyl acetate, 2-[2-oxo-2-phenylacetoxyethoxy]ethylester, and oxyphenyl acetate, 2-(2-hydroxyethoxy)ethyl ester), Lucirin TPO, LR8893, and LR8970 (all manufactured by BASF Japan), KAYACURE DETX-S (2,4-diethylthioxanthone) (manufactured by Nippon Kayaku Co., Ltd.), Uvecryl P36 (manufactured by UCB), Speedcure TPO (diphenyl-2,4,6-trimethylbenzoyl phosphine oxide), and Speedcure TPO (diphenyl-(2,4,6-trimethylbenzoyl)phosphine oxide) (all manufactured by Lambson), and the like.

The photopolymerization initiators may be used alone or in combination of two or more kinds thereof.

The content of the photopolymerization initiator is preferably 0.5% by mass or more and 15% by mass or less and more preferably 1.0% by mass or more and 10% by mass or less based on the total mass of the radiation curing type ink jet ink composition. When the content of the photopolymerization initiator falls under the ranges mentioned above, the ultraviolet curing rate is sufficiently high and coloring resulting from an unmelted residue of the photopolymerization initiator or the photopolymerization initiator hardly occurs. As described above, when the photopolymerization initiators contained in the ink jet composition are an acylphosphine oxide compound and/or a thioxanthone compound, the content of the acylphosphine oxide compound is preferably 2% by mass or more based on the total mass of the radiation curing type ink jet ink composition. On the other hand, the content of the thioxanthone compound is preferably 1% by mass or more based on the total mass of the radiation curing type ink jet ink composition.

By the use of the photopolymerizable compound as the monomer described above, the addition of the photopolymerization initiator can be omitted. However, the use of the photopolymerization initiator is preferable because the initiation of polymerization can be easily adjusted.

### 1.2.4. Surfactant

The radiation curing type ink jet ink composition according to this embodiment can further contain a surfactant. Examples of the surfactant include, but are not particularly limited thereto, a silicone-based surfactant (for example, BYK UV3500 and UV3570 (manufactured by BYK Chemie Japan, Trade name) as a commercially-available item) and an acryl-based surfactant (BYK350 (manufactured by BYK Chemie Japan, Trade name)), for example. Among the above, due to the fact that the silicone-based surfactant is contained, the surface tension reduction ability is excellent, the wettability to a recording medium is increased, the solid filling is more excellent, and the surface tension is easily adjusted.

The content of the surfactant is preferably 0.01% by mass or more and 2% by mass or less and more preferably 0.05% by mass or more and 1% by mass or less based on the total mass (100% by mass) of the radiation curing type ink jet ink composition. Due to the fact the content of the surfactant falls under the ranges mentioned above, the wettability to a recording medium can be made more excellent, the liquid repellency of a head nozzle plate can be kept good, and the discharge stability can be made more excellent.

As the silicone-based surfactant, a polysiloxane-based compound is preferably used, and, for example, polyether-modified organosiloxane is mentioned. Moreover, commercially-available items are usable and, for example, BYK-306, BYK-307, BYK-333, BYK-341, BYK-345, BYK-346, and BYK-348 (all Trade names, manufactured by BYK Chemie Japan, Inc.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all Trade names, manufactured by Shin-Etsu Chemical Co., Ltd.) are mentioned.

### 1.2.5. Dispersant

The radiation curing type ink jet ink composition may further contain a dispersant in order to further improve the pigment dispersibility. Examples of the dispersant include, but are not particularly limited thereto, dispersants commonly used for preparing pigment dispersion liquid, such as a polymer dispersant, for example. Specific examples thereof include those containing at least one or more kinds of polyoxyalkylene polyalkylene polyamine, vinyl-based polymers and copolymers, acryl-based polymers and copolymers, polyesters, polyamides, polyimides, polyurethanes, amino-based polymers, silicon containing polymers, sulfur containing polymers, fluorine containing polymers, and epoxy resin as the main component. Examples of commercially-available items of the polymer dispersant include AJISPER series manufactured by Ajinomoto Fine-Techno Co., Inc., Solsperse series (Solsperse 36000 and the like) available from Avecia or Noveon, Disper BYK series available from BYK Chemie, and Disperon series manufactured by Kusumoto Chemicals, Ltd.

### 1.2.6. Other Additives

The radiation curing type ink jet ink composition according to this embodiment may further contain additives, such as a polymerization inhibitor, a photosensitizer, and a polymerization inhibitor, as necessary.

### Polymerization Inhibitor

The radiation curing type ink jet ink composition according to this embodiment may further contain a hindered amine compound or other substances as the polymerization inhibitor. Examples of the other polymerization inhibitors include, but are not particularly limited thereto, p-methoxy phenol, hydroquinone monomethylether (MEHQ), hydroquinone, cresol, t-butyl catechol, 3,5-di-t-butyl-4-hydroxytoluene, 2,2′-methylene bis(4-methyl-6-t-butylphenol), 2,2′-methylene bis(4-ethyl-6-t-butylphenol), and 4,4′-thio bis(3-methyl-6-t-butylphenol), for example. The polymerization inhibitors may be used alone or in combination of two or more kinds thereof.

The total content of the polymerization inhibitors is preferably 0.05% by mass or more and 0.5% by mass or less and more preferably 0.1% by mass or more and 0.5% by mass or less based on the total mass (100% by mass) of the ink jet ink composition.

### Photosensitizer

The radiation curing type ink jet ink composition according to this embodiment may further contain a photosensitizer. Examples of the photosensitizer include amine compounds (aliphatic amine, amine containing an aromatic group, piperidine, a reaction product of epoxy resin and amine, triethanolamine triacrylate, and the like), urea compounds (allylthio urea, o-tolylthio urea, and the like), sulfur compounds (sodium diethyl dithiophosphate, soluble salts of aromatic sulfinic acid, and the like), nitrile-based compounds (N,N-diethyl-p-aminobenzonitrile and the like), phosphorus compounds (tri-n-butyl phosphine, sodium diethyl dithiophosphide, and the like), nitrogen compounds (Michler's Ketone, N-nitrisohydroxylamine derivatives, oxazolidine compounds, tetrahydro-1,3-oxazine compounds, condensates of formaldehyde or acetaldehyde and diamine, and the like), chlorine compounds (carbon tetrachloride, hexachloroethane, and the like), and the like.

### 1.2.7. Physical Properties

The viscosity at 20° C. of the radiation curing type ink jet ink composition according to this embodiment is preferably 25 mPa·s or less and more preferably 5 to 20 mPa·s. When the viscosity at 20° C. of the composition falls under the ranges mentioned above, a proper amount of the composition is discharged from a nozzle and the curved flight and the scattering of the composition can be further reduced, and therefore the composition can be preferably used for an ink jet recording apparatus. With respect to the measurement of the viscosity, the viscosity can be measured using a viscoelasticity tester MCR-300 (manufactured by Pysica) by increasing the Shear Rate to 10 to 1000 in a 20° C. environment, and then reading the viscosity at the Shear Rate of 200.

The surface tension at 20° C. of the radiation curing type ink jet ink composition according to this embodiment is preferably 20 mN/m or more and 30 mN/m or less. When the surface tension at 20° C. of the composition falls under the range mentioned above, the composition becomes difficult to be wet with a nozzle subjected to liquid repellent treatment. Thus, a proper amount of the composition is discharged from the nozzle and the curved flight and the scattering of the composition can be further reduced, and therefore the composition can be preferably used for an ink jet recording apparatus. With respect to the measurement of the surface tension, the surface tension can be measured using an automatic surface tension meter CBVP-Z (manufactured by Kyowa Interface Science Co., LTD.) by confirming the surface tension when a platinum plate is wet with the composition under a 20° C. environment.

In the radiation curing type ink jet ink composition according to this embodiment, the dissolved oxygen concentration of an ink is preferably 10 kPa or less from the viewpoint of discharge stability or storage stability. Due to the fact that the dissolved oxygen concentration of an ink is 10 kPa or less, cavitation in a head becomes difficult to occur, so that an image recording method having more excellent discharge stability can be provided. A method for measuring the dissolved oxygen amount is not limited to the following method and the amount can be measured by a polarograph system, for example, and can be measured using a DO meter UC-12-SOL type manufactured by CENTRAL KAGAKU CORP, for example. The ink may have a dissolved oxygen amount of 10 kPa or less when discharged from a nozzle of a head. When an ink is prepared (when an ink is produced), the dissolved oxygen amount may be set to kPa or less. The lower limit of the dissolved oxygen amount of an ink is not limited and is preferably 1 kPa or more and more preferably 3 kPa or more. The upper limit is more preferably 8 kPa or less and still more preferably 6 kPa or less. When the dissolved oxygen amount falls under the ranges mentioned above, the discharge stability and the storage stability when discharged from a head are more excellent.

The dissolved oxygen amount of an ink can be set in the rages above by performing treatment described later as treatment for reducing the dissolved oxygen amount in preparing an ink, for example.

### 1.2.8. Method for Producing Ink

With respect to the production (preparation) of an ink jet ink composition, the ink jet ink composition can be prepared by mixing each component contained in an ink, and then stirring the mixture so that the components are sufficiently uniformly mixed. In this embodiment, the preparation of an ink preferably has a process of subjecting a mixture in which a photopolymerization initiator and at least one part of a polymerizable compound are mixed to deaeration treatment in the preparation process. Thus, the dissolved oxygen amount of the ink after the preparation can be reduced, so that a composition excellent in discharge stability or storage stability can be obtained. The mixture may be one containing at least the components described above, one further containing other components to be contained in an ink, or may be one containing all the components to be contained in an ink. The polymerizable compound contained in the mixture may be at least one part of the polymerizable compound contained in the ink.

As the deaeration treatment, known methods are usable. It is preferable for the methods to have a process of performing at least any one of various kinds of deaeration treatment, such as ultrasonic treatment, pressure reducing treatment, centrifugal treatment, warming treatment, and babbling of inactive gas.

### Ultrasonic Treatment

In the ink preparation, air bubbles adhering to and remaining on the inside and the surface of particles of the photopolymerization initiator and the pigment are separated from the particles by the ultrasonic treatment to be emitted into the ink, and then the emitted air bubbles are ejected from the ink by the vibration of sonic waves. Thus, when the ink is discharged from a head, cavitation is difficult to occur in the head, and therefore poor discharge due to nozzle clogging is prevented and the discharge stability is improved.

The ultrasonic treatment can be performed by providing an ultrasonic transducer in a container storing the ink or on the wall surface thereof. The ultrasonic treatment may be performed using those capable of emitting ultrasonic waves to a mixture, such as ultrasonic dispersers, e.g., GSD150AT (manufactured by Ginsen), GSD300AT (manufactured by Ginsen), GSD600AT (manufactured by Ginsen), GSD1200AT (manufactured by Ginsen), GSD600MCVP-5 (manufactured by Ginsen), GSD600MCVP-10 (manufactured by Ginsen), GSD600MAT-5 (manufactured by Ginsen), GSD600MAT-10 (manufactured by Ginsen), GSD1200MAT-10 (manufactured by Ginsen), UH-50 (manufactured by SMT Corporation), UH-150 (manufactured by SMT Corporation), UH-300 (manufactured by SMT Corporation), UH-600 (manufactured by SMT Corporation), UH-600S (manufactured by SMT Corporation), UH-600SR (manufactured by SMT Corporation), UH-1200SR (manufactured by SMT Corporation), UH-600SR-1 (manufactured by SMT Corporation), UH-1200SR-1 (manufactured by SMT Corporation), UH-600SR-2 (manufactured by SMT Corporation), and UH-600SR-3 (manufactured by SMT Corporation), or using an ultrasonic cleaning machine.

The treatment time of the ultrasonic treatment is preferably 20 minutes or more and 200 minutes or less and more preferably 30 minutes or more and 100 minutes or less in terms of sufficiently obtaining the above-described effects or in terms of improving the efficiency of the ink preparation. The output of the ultrasonic waves of the ultrasonic treatment is preferably 400 W or more and 1000 W or less and more preferably 400 W or more and 800 W or less in the same respects. The frequency of the ultrasonic waves of the ultrasonic treatment is preferably 20 kHz or more and kHz or less in the same respects. The ultrasonic treatment may be performed under reduced pressure. The pressure reducing treatment can be performed by the same method as a method described later.

In the ultrasonic treatment, other treatment may be further performed while emitting ultrasonic waves or before or after the ultrasonic treatment. Examples of the other treatment include stirring, heating, deaeration under reduced pressure, and the like. The other treatment mentioned above may be performed to one obtained by adding the remaining components to the mixture treated with ultrasonic waves.

### Warming Treatment

In the ink preparation, by performing warming treatment of performing warming in place of or in addition to the ultrasonic treatment to a mixture similar to the mixture to be subjected to the ultrasonic treatment described above, the same effects as those obtained by the ultrasonic treatment are obtained.

The warming is preferably performed at 30° C. or more as the temperature of the mixture in terms of obtaining the above-described effects, more preferably at 40° C. or more in terms of obtaining the above-described effects, still more preferably at 40° C. or more and 80° C. or less, and yet still more preferably at 40° C. or more and 75° C. or less. The treatment time of the warming treatment can be adjusted as appropriate and is preferably 48 hours or less, more preferably 24 hours or less, and still more preferably 20 minutes or more and 200 minutes or less in terms of sufficiently obtaining the above-described effects or improving the efficiency of the ink preparation. The warming may be performed by directly or indirectly applying heat emitted from a heating element to the ink, emitting infrared rays, or the like.

In the warming treatment, other treatment may be further performed while performing warming or before or after the warming. Examples of the other treatment include stirring, deaeration under reduced pressure, ultrasonic waves, and the like. It is particularly preferable to perform stirring as with the ultrasonic treatment.

### Pressure Reducing Treatment

The pressure reducing treatment is treatment for deaerating the mixture described above or the ink after the preparation under reduced pressure and is treatment for ejecting air bubbles, which are separated from the photopolymerization initiator or the pigment in the mixture or the ink to be emitted into the ink, from the ink. It is preferable to perform the deaeration under reduced pressure using a pressure reducing pump or the like under reduced pressure of −50 kPa or more and −90 MPa or less and more preferably under reduced pressure of −70 kPa or more and −500 kPa or less. The pressure reducing treatment is preferably performed while stirring the mixture or the ink and is preferably performed while emitting ultrasonic waves or performing warming. The treatment time of the pressure reducing treatment is preferably 10 minutes or more and 100 minutes or less and more preferably 15 minutes or more and 40 minutes or less in terms of sufficiently obtaining the above-described effects or in terms of improving the efficiency of the ink preparation.

Next, an image recording method according to this embodiment is described.

### 1.3. Image Recording Method

According to the image recording method of this embodiment, recording is performed using the ink jet ink composition containing the above-described pigment having a maximum particle size of 2.5 μm or less with continuous scanning time of 10 minutes or more and includes, when recording is performed using the above-described ink jet recording apparatus, a process of causing the radiation curing type ink jet composition to adhere to a recording medium and a process of emitting light of a UV-LED (ultraviolet ray emitting diode) to the radiation curing type ink jet composition on the recording medium. Thus, a cured film is formed in a portion where the ink is applied onto the recording medium.

For example, with the printer 1 illustrated in FIG. 4, image recording is performed by a discharge operation of discharging the ink to the recording medium S facing the line heads K, C, M, and Y. Next, ultraviolet rays are emitted to the recording medium S by the irradiation portions for temporary curing 420a, 420b, 420c, and 420d disposed on the downstream side in the transporting direction of the line heads for temporarily curing the ink, and further ultraviolet rays are emitted to the recording medium S by the irradiation portion for complete curing 440 disposed on the downstream side in the transporting direction for completely curing the ink.

Herein, the “temporary curing” means pinning of the ink, and more specifically means curing of the ink before the complete curing for preventing blurring between dots or controlling the dot diameter. In general, the degree of polymerization of the polymerizable compound in the temporary curing is lower than the degree of polymerization of the polymerizable compound by the complete curing performed after the temporary curing. The “complete curing” refers to curing the dots formed on the recording medium to a cured state required to be used as recorded matter. Herein, when “curing” is referred to in this specification, the “curing” means the complete curing unless otherwise particularly specified.

Ultraviolet rays may be emitted by the irradiation portion for complete curing 440, so that the ink may be completely cured. Therefore, the curing operation may be ended by emitting ultraviolet rays from the irradiation portion for complete curing 440 instead of emitting ultraviolet rays from some or all of the irradiation portions for temporary curing 420a 420b, 420c, and 420d. Thus, as the curing operation, only the complete curing may be performed without performing the temporary curing.

In discharging the ink, the viscosity at 20° C. of the ink is set to preferably 25 mPa·s or less and more preferably 5 to 20 mPa·s as described above. When the viscosity of the ink falls under the ranges mentioned above, the ink can be discharged at room temperature as the temperature of the ink or without warming the ink. On the other hand, the ink is warmed to a predetermined temperature to set the viscosity to preferably viscosity, and then the ink may be discharged. Thus, good discharge stability is realized.

The radiation curing type ink jet composition has viscosity higher than the viscosity of an aqueous ink composition generally used in ink jetting, and therefore the viscosity changes due to the temperature changes in discharge are large. The viscosity changes of the composition considerably affect the liquid droplet size changes and the liquid droplet discharge speed changes, and further may cause image quality degradation. Therefore, the temperature of the ink in the discharge is preferably kept as constant as possible.

Examples of the recording medium include, but are not particularly limited thereto, plastics, such as polyvinyl chloride, polyethylene terephthalate, polypropylene, polyethylene, and polycarbonate, those obtained by performing surface treatment to the substances above, glass, coated paper, and the like, for example.

As described above, According to the image recording method of this embodiment, recording is performed using an ink jet ink composition containing a pigment having a maximum particle size of 2.5 μm or less with continuous scanning time of 10 minutes or more. The continuous scanning means continuously performing a plurality of image recording operations without interrupting the image recording operation.

In this embodiment, the printer 1 is a line printer performing recording with one pass printing of a line head having a width equal to or larger than the recording width of a recording medium, and therefore continuously performs the recording operation to a long recording medium S rolled in a roll shape. In the continuous scanning, the ink may be continuously discharged from all the nozzles provided in the head and all of the nozzles or some nozzles to be used may have non-discharging time, i.e., timing when the ink is not discharged in the continuous scanning, depending on an image to be recorded. The non-discharge time in this case is 10 seconds or less, preferably 1 second or less, and more preferably 0.1 second or less.

According to the image recording method of this embodiment, recording is performed using an ink jet ink composition containing a pigment having a maximum particle size of 2.5 μm or less with continuous scanning time of 10 minutes or more. Therefore, in the continuous scanning, cavitation in the head under the influence of flocculation of the pigment in the ink, dissolved oxygen, and the like is difficult to occur, so that an image recording method in which poor discharge due to nozzle clogging is reduced to achieve excellent discharge stability is obtained. Moreover, the image recording method has excellent discharge stability, and therefore high-speed continuous recording can be achieved.

In the case where the ink is caused to adhere by an ink jet method, the above-described effects obtained by the present invention are particularly high when the above-described ink is discharged using the apparatus having the piezoelectric ink jet head satisfying the following formula (1) as described above.

0.13≦{(Discharge amount per droplet)/(Capacity of ink pressure chamber)}×100 (1).

The head satisfying Formula (1) is likely to cause cavitation and is likely to cause poor discharge under the influence of the ink composition. However, in this embodiment, by the use of the ink containing a pigment having a maximum particle size of 2.5 μm or less, the cavitation in the head is difficult to occur, so that an image recording method excellent in discharge stability can be provided. Moreover, by the use of the piezoelectric ink jet head satisfying Formula (1), thin line representation can be improved.

Herein, the discharge amount per droplet can be adjusted as appropriate and is preferably 0.1 pl or more and 20 pl or less, more preferably 1 pl or more and 10 pl or less, still more preferably 3 pl or more and 9 pl or less, and yet still more preferably 5 pl or more and 8 pl or less. The capacity of the ink pressure chamber can be set as described above.

In the image recording method according to this embodiment, when the head satisfying the following formula (2) is used, the above-described effects obtained by the present invention is higher.

0.13≦{(Discharge amount per droplet)/(Capacity of ink pressure chamber)}×100≦0.18 (2)

The value of {(Discharge amount per droplet)/(Capacity of ink pressure chamber)}×100 is preferably 0.40 or less, more preferably 0.30 or less, still more preferably 0.20 or less, and yet still more preferably 0.18 or less. The effects are high when the value is 0.14 or more and 0.17 or less and the effects are higher when the value is 0.15 or more and 0.16 or less.

In the curing process, the composition applied onto the recording medium is cured by the emission of light of a UV-LED. More specifically, the coating film of the ink formed on the recording medium is formed into a cured film by the emission of the light of the UV-LED. This is because the photopolymerization initiator which may be contained in the ink is decomposed by the emission of ultraviolet rays, active species (initiation species), such as radical, acid, and a base, are generated, so that the polymerization reaction of the photopolymerizable compound is promoted by the function of the initiation species. Or, this is because the photopolymerization reaction of the polymerizable compound is initiated by the emission of ultraviolet rays. Herein, when a sensitizing dye is present with the photopolymerization initiator in the ink, the sensitizing dye in the system absorbs active radiation to enter the excitation state, and then contacts the photopolymerization initiator to thereby promote the decomposition of the photopolymerization initiator, whereby a curing reaction with higher sensitivity can be achieved.

By the use of the UV-LED as the ultraviolet ray source, a reduction in the size of the apparatus and the cost can be realized. The UV-LED as the ultraviolet ray source is small, and therefore can be attached to the inside of the ink jet recording apparatus. For example, the UV-LED can be attached to a carriage (both end portions along the medium width direction and/or on the medium transporting direction side) carrying the head discharging the ink. Furthermore, curing at low energy and at a high speed can be realized due to the composition of the ink described above. The irradiation energy is calculated by multiplying the irradiation time by the irradiation intensity. Therefore, the irradiation time can be shortened and the image recording speed increases. On the other hand, the irradiation intensity can also be reduced. Thus, an increase in the temperature of recorded matter can be reduced, which also leads to a reduction in odor of a cured film.

The irradiation energy is preferably 50 to 1000 mJ/cm², more preferably 100 to 700 mJ/cm², and particularly preferably 200 to 600 mJ/cm² from the viewpoint of reducing the malodor of the cured film.

The irradiation intensity is preferably 10 to 1000 mW/cm², more preferably 30 to 700 mW/cm², and particularly preferably 50 to 500 mW/cm² from the viewpoint of reducing the malodor of the cured film.

The temperature of the recording medium in recording is preferably less than 45° C., more preferably 40° C. or less, and particularly preferably 35° C. or less. By setting the temperature of the recording medium in recording in the ranges mentioned above, the temperature of the recording medium is lower than the molar average Tg of the monofunctional monomer in the composition. Therefore, the volatilization of the monomer into the atmosphere after forming the coating film is prevented, and the reduction in odor can be achieved.

Furthermore, the ink discharge amount (adhesion amount, charge amount) per unit area in the discharge to the recording medium S is preferably 5 to 16 mg/inch² in order to prevent wasteful use of the ink.

As described above, when the printer 1 has the deaeration unit in this embodiment, the deaeration is performed until the ink is supplied to each piezoelectric ink jet head 100 to reduce the dissolved oxygen concentration of the ink, and then the ink is discharged. Thus, the occurrence of cavitation in the head is prevented and the discharge stability is improved. Moreover, in this embodiment, the line head is used and the ink use amount is large, and therefore, when the deaeration unit is provided, the discharge stability is improved.

### 2. EXAMPLES

Hereinafter, the present invention is described with reference to Examples and Comparative Examples but the present invention is not limited only to Examples. In Examples and Comparative Examples, “part(s)” and “%” are on a mass basis unless otherwise particularly specified.

### 2.1. Preparation of Ink Composition

First, a pigment, a dispersant, and some of the monomers were weighed and placed in a pigment dispersion tank, and then a ceramic bead mill having a diameter of 1 mm was placed in the tank for stirring, whereby a pigment dispersion liquid in which the pigment was dispersed in a polymerizable compound was obtained. Subsequently, the remaining monomers, a polymerization initiator, a sensitizer, a polymerization inhibitor, and a surfactant were placed in a tank for mixture which is a stainless steel container so as to have the compositions of inks Y1 to Y3 shown in Table 1, and then mixed and stirred to be completely dissolved. Thereafter, the pigment dispersion liquid obtained above was charged, the mixture was further mixed and stirred at normal temperature for 1 hour, and then the resultant mixture was filtered under pressure through various filters different in the pore size described later, whereby Examples 1 to 9 and Comparative Examples 1 to 5 in which the size of the coarse particles contained in the ink was controlled were obtained. Each ink was subjected to deoxidation treatment described later after the filtering, whereby the dissolved oxygen concentration in the ink was adjusted.

TABLE 1

| | | | Average | | | |
|---|---|---|---|---|---|---|
| | | Pigment | pigment particle | | | |
| | Product Name | aspect ratio | size (nm) | Ink Y1 | Ink Y2 | Ink Y3 |
| Pigment | P.Y.155 Dispersion liquid | 45 | 235 | 15 | 15 | |
| dispersion | (15% pigment concentration) | | | | | |
| liquid (PEA | P.Y.180 Dispersion liquid | 1.5 | 110 | | | 15 |
| base) | (15% pigment concentration) | | | | | |
| Monomer | VEEA | | | 30 | 20 | 30 |
| | PEA | | | 27.15 | 22.15 | 27.15 |
| | DPGDA | | | 15 | 5 | 15 |
| | IBX-A | | | | 25 | |
| Polymerization | TPO | | | 4.5 | 4.5 | 4.5 |
| initiator and | 819 | | | 4.8 | 4.8 | 4.8 |
| Sensitizer | DETX | | | 3 | 3 | 3 |
| Polymerization | MEHQ | | | 0.05 | 0.05 | 0.05 |
| inhibitor | | | | | | |
| Surfactant | BYK-UV3500 | | | 0.5 | 0.5 | 0.5 |
| | Total | | | 100 | 100 | 100 |

The components represented by the abbreviations used in Table 1 are as follows.

### Pigment

### PY155 (C.I. Pigment Yellow 155)

### PY180 (C.I. Pigment Yellow 180)

### Monomer

VEEA (Trade name, manufactured by NIPPON SHOKUBAI, 2-(2-vinyloxyethoxy)ethyl acrylate)
PEA (Trade name “Viscoat #192, manufactured by Osaka Organic Chemical Industry Co., Ltd., Phenoxyethyl acrylate”)
DPGDA (Trade name “SR508”, manufactured by Sartomer Japan, Inc., Dipropylene glycol diacrylate)
IBX-A (Trade name, manufactured by Osaka Organic Chemical Industry Co., Ltd., Isobornyl acrylate)

### Polymerization Initiator and Sensitizer

TPO (Trade name, “DAROCUR TPO”, manufactured by BASF A.G., 2,4,6-trimethylbenzoyl diphenyl phosphine oxide)
819 (Trade name, “IRGACURE 819”, manufactured by BASF A.G., Bis(2,4,6-trimethyl benzoyl)-phenyl phosphine oxide)
DETX (Trade name, “KAYACURE DETX-S”, manufactured by Nippon Kayaku Co., Ltd., Bis(2,4-diethyl thioxanthene-9-one)

### Polymerization Inhibitor

MEHQ (Trade name, “p-methoxy phenol”, manufactured by Kanto Kagaku, Inc., Hydroquinone monomethylether)

### Surfactant (Slipping Agent)

BYK-UV3500 (Trade name, manufactured by BYK Additives&Instruments, Polyether-modified polydimethyl siloxane having acryl group)

The pigment aspect ratio and the average pigment particle size shown in Table 1 were measured by the following methods.

### Method for Measuring Pigment Aspect Ratio

The pigment aspect ratio was calculated from the observation by a scanning electron microscope (SEM; manufactured by Hitachi High-Technologies Corporation, Field emission scanning electron microscope S-4500). First, a sample obtained by dropping an ink sample on a photopaper, thinly spreading the same, and then drying the same was used. Next, the particles within a visual field were photographed by a SEM. Then, 50 pigment particles were measured for each of the length of the longer diameter (major axis) and the length of the shorter diameter (minor axis). Then, Average major axis/Average minor axis was defined as the aspect ratio.

### Method for Measuring Average Pigment Particle Size

The average pigment particle size was measured using a laser diffracting/scattering particle size distribution meter (manufactured by MictotracBEL, Microtrac UPA150). First, each ink sample was diluted with EDGAC (ethyldiglycolacetate). Next, using the UPA150, the particle size distribution measurement was carried out to determine D50 from the measurement result, and then the value was defined as the average particle size.

In inks Y1 to Y3, the size of coarse particle contained in the inks and the dissolved oxygen concentration were adjusted, whereby Examples and Comparative Examples shown in Table 2 below were obtained.

TABLE 2

| Item | Ex. 1 | Ex. 2 | Ex. 3 | Ex. 4 | Ex. 5 | Ex. 6 | Ex. 7 |
|---|---|---|---|---|---|---|---|
| Y ink name | Y1 | Y1 | Y1 | Y1 | Y1 | Y1 | Y2 |
| Filter conditions | D | D | D | D | E | F | D |
| Maximum particle size | 2.0 μm | 2.0 μm | 2.0 μm | 2.0 μm | 1.7 μm | 1.5 μm | 2.0 μm |
| Deoxidation conditions | Deaeration A | Deaeration B | Heating A | None | Deaeration A | Deaeration B | Heating A |
| DO value | 9 kPa | 6 kPa | 8 kPa | 14 kPa | 9 kPa | 6 kPa | 8 kPa |
| \|(Discharge amount per droplet)/ | 0.16 | 0.16 | 0.16 | 0.16 | 0.16 | 0.16 | 0.16 |
| (Capacity of ink pressure | | | | | | | |
| chamber)} × 100\| | | | | | | | |
| Continuous printing | A | A | A | B | A | A | A |
| Color development | A | A | A | A | A | A | A |
| Lightfastness | A | A | A | A | A | A | A |
| Item | Ex. 8 | Ex. 9 | Ex. 10 | Comp. Ex. 1 | Comp. Ex. 2 | Comp. Ex. 3 | Comp. Ex. 4 |
| Y ink name | Y1 | Y1 | Y3 | Y1 | Y1 | Y1 | Y1 |
| Filter conditions | C | D | D | B | B | A | A |
| Maximum particle size | 2.5 μm | 2.0 μm | 2.0 μm | 3.0 μm | 3.0 μtm | 4.0 μm | 4.0 μm |
| Deoxidation conditions | Deaeration A | None | Deaeration A | Deaeration A | None | Deaeration A | Deaeration B |
| DO value | 9 kPa | 14 kPa | 9 kPa | 9 kPa | 14 kPa | 9 kPa | 6 kPa |
| \|(Discharge amount per droplet)/ | 0.16 | 0.12 | 0.16 | 0.16 | 0.16 | 0.16 | 0.16 |
| (Capacity of ink pressure | | | | | | | |
| chamber)} × 100\| | | | | | | | |
| Continuous printing | A | A | A | C | D | D | D |
| Color development | A | B | A | A | A | A | A |
| Lightfastness | A | A | B | A | A | A | A |

### Filter Conditions

A: Manufactured by Japan Pall Corporation, Profile II 10.0 μm in pore size
B: Manufactured by Japan Pall Corporation, Profile II 5.0 μm in pore size
C: Manufactured by Japan Pall Corporation, Profile II 1.5 μm in pore size
D: Manufactured by Japan Pall Corporation, Profile II 1.0 μm in pore size
E: Manufactured by Japan Pall Corporation, Profile II 0.5 μm in pore size
F: Manufactured by Japan Pall Corporation, Ultipleat 0.45 μm in pore size

### Deoxidation Treatment Conditions

Deaeration A: Stirring deaeration under reduced pressure 90 kPa, 15 minutes, 300 rpm)
Deaeration B: Vacuum ultrasonic deaeration (−90 kPa, 30 minutes, 25 kHz)
Heating A: Ink aging (70° C., 24 hour heating)

In the deaeration A, the obtained ink was charged and sealed in a device having a stirring mechanism and a pressure reducing pump, and then stirred under reduced pressure at 300 rpm for 15 minutes while reducing the pressure to −90 kPa with the vacuum pump. In the deaeration B, the obtained ink was charged and sealed in a tank (Vacuum ultrasonic deaeration device, VSD-101, manufactured by Chiyoda Electric Co., Ltd.) having an ultrasonic transducer, and then 28 kHz ultrasonic waves were emitted thereto for 30 minutes while reducing the pressure to −90 kPa with a vacuum pump. In the heating A, the obtained ink was placed in an airtight container, and then placed in an oven set to 70° C. to be heat treated for 24 hours.

### 2.2. Evaluation Method

### 2.2.1. Measurement of Coarse Particle Size in Ink

The obtained ink sample was diluted with EDGAC (ethyldiglycolacetate) to 3000 times, 20 ml of the diluted sample was charged in an AccuSizer 780APS (manufactured by PSS Japan), and then the coarse particle size was measured under the following conditions.

### AccuSizer Conditions

Injected sample amount: 20 ml
Flow velocity: 1 ml/s
Number of channels: 128
Measurement principle: Number count system by light shielding method
Definition of maximum particle size: The particle size when the number of coarse particles exceeded 400 particles/20 ml was defined as the maximum particle size.

### 2.2.2. Measurement of Dissolved Oxygen Concentration (DO Value) of Ink

The measurement of the dissolved oxygen concentration of the ink was performed using a DO meter UC-12-SOL type manufactured by CENTRAL KAGAKU CORP.

### 2.2.3. Continuous Printing Evaluation

As a line printer, SurePress L-4033A (manufactured by Seiko Epson Corp.) was converted as follows to be used. As illustrated in FIG. 4, four line heads (head having a length almost equivalent to the width (recording width) in which an image is to be recorded of a recording medium) were arranged in the transporting direction of a recording medium, and a light source was disposed on the downstream in the transporting direction of each head. In the recording by the line printer, the head K, the irradiation portion for temporary curing 420a, and the irradiation portion for complete curing 440 were used among the heads and the light sources illustrated in FIG. 4 and the other elements were not used. The transporting drum 260 was made of aluminum, the diameter of the transporting drum 260 was set to 500 mm, the recording speed was set to 285 mm/second, and the drum rotation cycle was set to 5.5 seconds. As the head, one having a nozzle density in a target recording medium width direction of the nozzle array was 600 dpi was used.

The ink composition shown in Table 1 was discharged from the head K to a PET film (Lumirror S10 manufactured by TORAY (100 μm in thickness)) under the conditions of a recording resolution 600 dpi×600 dpi and one pass (single pass). Herein, the ink droplet amount per pixel was adjusted so that the film thickness after curing was 10 μm. Thus, a solid pattern image was formed. The “solid pattern image” means an image in which dots are recorded to all the pixels which are the minimum recording unit region specified by the recording resolution and the base of the recording medium in the pattern was completely covered with the ink.

The solid pattern image was continuously printed for 10 minutes, the nozzles were checked before and after the printing, and then an increase in the number of nozzle omissions and bent nozzles were evaluated to be defined as the index of the discharge stability in the continuous printing. When evaluated as A or B, it can be said that the above-described effects of the present invention are obtained.

### Evaluation Criteria

A: The number of nozzle omissions and bent nozzles is zero.
B: The number of nozzle omissions and bent nozzles is 1 to 5.
C: The number of nozzle omissions and bent nozzles is 6 to 10.
D: The number of nozzle omissions and bent nozzles is 11 or more.

The ink adhering to the PET film was irradiated with ultraviolet rays from the light source, so that an ink composition was cured. Specifically, an LED having a peak wavelength of 395 nm and an irradiation peak intensity of 500 mW/cm² was first used as the light source 420a. From the LED, ultraviolet rays with irradiation energy of 20 mJ/cm² were emitted for temporary curing. An LED having a peak wavelength of 395 nm and irradiation peak intensity of 1,500 mW/cm² was used as the light source 440. From the LED, ultraviolet rays with irradiation energy of 400 mJ/cm² were emitted for predetermined period of time to cure the solid pattern image. Thus, a cured film having a film thicknesses of 10 μm in which the solid pattern image was cured was obtained. It was confirmed that there was no tack feeling of the cured film surface by a touch test.

As the used printer heads, a head in which (Discharge amount per droplet/(Capacity of ink pressure chamber)}×100 is 0.16 illustrated in FIG. 3 and a head in which the capacity of the pressure chamber was larger than that of the head described above, the nozzle pressure was further reduced, and (Discharge amount per droplet/(Capacity of ink pressure chamber)}×100 is 0.12 were used.

### 2.2.4. Color Development Evaluation

### OD Value of Solid Pattern

The OD value (OD-Y) of the cured film of the solid pattern used for Continuous printing evaluation above was measured using Spectrolino (manufactured by Gretag) to be defined as the index for color development evaluation.

### Evaluation Criteria

A: The OD value is 1.9 or more.
B: The OD value is 1.7 or more and less than 1.9.
C: The OD value is 1.5 or more and less than 1.7.
D: The OD value is less than 1.5.

### 2.2.5. Lightfastness Evaluation

The obtained printed image was irradiated at an output with 320 W/m illuminance in a 50° C. environment for 400 hours with a xenon fadeometer (manufactured by Toyo Seiki Seisaku-sho, Ltd., Trade name: Suntest XLS+). For the hue evaluation, the initial color of the solid printed image and the color after the lightfastness test was performed were measured by Macbeth CE-7000 spectrum photometer (manufactured by Macbeth), and then the coordinates of the L*a*b* color system of the color difference display method specified in CIE. The color difference between the initial color of the printed image and the color after the lightfastness evaluation was determined from the measured L*a*b* value, and then evaluated according to the following evaluation criteria. The color difference is defined by the following formula,

Color difference: ΔE*ab=[(ΔL*)²+(Δa*)²+(Δb*)²]^{1/2}.

### Evaluation Criteria

### A: ΔE*ab≦5

### B: 5<ΔE*ab≦10

### C: 10<ΔE*ab

### 2.3. Evaluation Results

The evaluation results of Examples and Comparative Examples are shown in Table 2.

Referring to Examples and Comparative Examples based on Example 1 shown in Table 2, the number of nozzle omissions and bent nozzles was small even after the continuous printing for 10 minutes and the discharge stability was excellent in Examples in which the maximum pigment particle size was 2.5 μm or less. Particularly in Examples 1 to 3 and 5 to 9 in which the dissolved oxygen concentration in the ink was low, no nozzle omissions and no bent nozzles were observed. On the other hand, in Comparative Examples 1 to 4 in which the maximum pigment particle size exceeded 2.5 μm, a large number of nozzle omissions and bent nozzles were observed after the continuous printing for 10 minutes and the discharge stability was inferior. In Examples, when the continuous printing is evaluated as A or B, it can be said that the above-described effects of the present invention are obtained.

In Examples 4 and 9 in which the deoxidation treatment was not performed, the dissolved oxygen concentration in the ink was high and the discharge stability in the continuous printing was somewhat inferior to other Examples in Example 4 but the head in which {(Discharge amount per droplet)/(Capacity of ink pressure chamber)}×100 is 0.12 was in Example 9, and therefore there was no influence due to the high dissolved oxygen concentration.

The invention is not limited to the above-described embodiments, and can be modified in various manners. For example, the invention includes the substantially same structure (e.g., structure with same function(s), method(s), and result(s) or structure with the same object(s) and effect(s)) as the structures described with the embodiment. The invention also includes a structure in which non-essential portions of the structures described in the embodiments are replaced. The invention also includes a structure that can demonstrate the same effects or a structure that can achieve the same objects as those in the structures described with the embodiment. The invention also includes a structure in which known techniques are added to the structures described in the embodiment.

The entire disclosure of Japanese Patent Application No. 2016-123669, filed Jun. 22, 2016 is expressly incorporated by reference herein.

What is claimed is:

1. An image recording method using an ink jet ink composition containing a pigment, wherein
a maximum particle size of the pigment is 2.5 μm or less, and
recording is performed with continuous scanning time of 10 minutes or more.

2. The image recording method according to claim 1, wherein recording is performed with one pass printing using a line printer having a line head having a width equal to or larger than a recording width of a recording medium.

3. The image recording method according to claim 1, wherein a dissolved oxygen concentration of the ink jet ink composition is 10 kPa or less.

4. The image recording method according to claim 1, wherein the pigment has an aspect ratio of 2.5 or more and an average particle size of 170 nm or more.

5. The image recording method according to claim 1, wherein the ink jet ink composition is a radiation curing type ink jet ink composition.

6. The image recording method according to claim 5 comprising:
at least one kind selected from the group consisting of a compound represented by General Formula (I) shown below and monofunctional (meth)acrylate having an aromatic ring skeleton other than the compound represented by General Formula (I) shown below,
CH₂═CR¹—COOR²—O—CH═CH—R³ (I),
wherein, in Formula (I), R² is a hydrogen atom or a methyl group, R² is a divalent organic residue having 2 to 20 carbon atoms, and R³ is a hydrogen atom or a monovalent organic residue having 1 to 11 carbon atoms.

7. The image recording method according to claim 1, comprising at least one kind selected from the group consisting of C.I. Pigment Yellow 155, C.I. Pigment Yellow 128, and C.I. Pigment Red 122 as the pigment.

8. The image recording method according to claim 2 comprising discharging droplets by drop by drop from a nozzle using a piezoelectric ink jet head having an ink pressure chamber, wherein recording is performed using at least a droplet satisfying Formula (1) shown below,
0.13≦{(Discharge amount per droplet)/(Capacity of ink pressure chamber)}×100 (1).

9. An ink jet ink composition, which is used for the image recording method according to claim 1.

10. An ink jet ink composition, which is used for the image recording method according to claim 2.

11. An ink jet ink composition, which is used for the image recording method according to claim 3.

12. An ink jet ink composition, which is used for the image recording method according to claim 4.

13. An ink jet ink composition, which is used for the image recording method according to claim 5.

14. An ink jet ink composition, which is used for the image recording method according to claim 6.

15. An ink jet ink composition, which is used for the image recording method according to claim 7.

16. An ink jet ink composition, which is used for the image recording method according to claim 8.
